(19) United States
(12) Patent Application Publication
(10) Pub. No.: US 2019/0332261 A1
(43) Pub. Date: Oct. 31, 2019

(54) STORAGE SYSTEM, METHOD OF CONTROLLING STORAGE SYSTEM, AND MANAGEMENT NODE

(71) Applicant: HITACHI, LTD., Tokyo (JP)

(72) Inventors: Takayuki FUKATANI, Tokyo (JP); Tomohiro KAWAGUCHI, Tokyo (JP)

(73) Assignee: HITACHI, LTD., Tokyo (JP)

(21) Appl. No.: 16/352,058

(22) Filed: Mar. 13, 2019

(30) Foreign Application Priority Data
Apr. 26, 2018 (JP) 2018-085092

(51) Int. Cl. G06F 3/06

(52) U.S. Cl. CPC G06F 3/061; G06F 3/0679; G06F 3/0631

(57) ABSTRACT

A storage system includes a first storage device and a second storage device having different performances. A processor manages a volume having a storage region to which a storage device is allocated and performs an input/output of data for the storage device via the volume, the processor calculates an input/output frequency relating to the input or/and the output of the data for each storage region and manages volume configuration relating to an allocation amount of each of the first and second storage devices to the volume, a management unit acquires the input/output frequency from the processor and generates distribution information of the input/output frequency for each volume, and the management unit determines performance of the volume on the basis of the distribution information of the input/output frequency in the volume and the volume configuration of the storage device of each performance to the volume.

### CLAIM OF PRIORITY

The present application claims priority from Japanese patent application JP 2018-85092 filed on Apr. 26, 2018, the content of which is hereby incorporated by reference into this application.

### BACKGROUND OF THE INVENTION

1. Field of the Invention

The present invention relates to a storage system that provides volumes having different performances.

### 2. Description of the Related Art

As a storage device used in a storage system, in addition to one or more hard disk drive (HDD), one or more nonvolatile storage device such as a solid state drive (SSD) is in widespread use. HDD is superior in cost performance per bit because of its increased capacity. On the other hand, SSD is superior in performance (for example, IOPS or a sequential read speed) because of its increased speed.

As a storage system using a plurality of storage devices, for example, thin provisioning for managing physical devices as a virtual capacity pool is known (for example, refer to JP 2003-015915 A).

Further, there is a known technology performed in a storage pool including a high-performance drives (SSDs) and high cost-performance drives (HDDs). The technology allocates the high-performance SSDs preferentially to volumes of high priority and then allocates the remaining SSDs to other volumes (for example, refer to JP 2012-043407 A).

### SUMMARY OF THE INVENTION

The software defined storage (hereinafter, referred to as the SDS) is known as a method of effectively using storage resources of storage devices or servers. It is demanded for the SDS to operate without a dedicated storage administrator to reduce the management cost.

On the other hand, in the SDS consisting of a large number of nodes, the number of storage devices or nodes may greatly increases and it is difficult to perform conventional resource usage monitoring that monitors each node manually.

In a storage system that performs priority control for each type of volumes by using a storage pool including storage devices having different performances, even if a capacity of the storage pool has a margin, performance becomes insufficient when a capacity of storage devices (SSD) with high performance is insufficient. The storage administrator needs to add an SSD before the capacity of the SSDs becomes insufficient, thereby preventing performance degradation.

However, in the related art, since a storage administrator receives system alerts only when a free capacity of the storage pool is insufficient, the storage administrator cannot notice a shortage of performance even when the SSD capacity is insufficient. For this reason, the storage administrator cannot realize the shortage of the high-performance storage devices until the performance problems really occur in user applications or services actually accessing the storage system.

Accordingly, the present invention has been made in view of the above problems and an object thereof is to provide a storage system for performing priority control for each type of volumes, which detects a shortage of high-performance storage devices and notifying a storage administrator of the shortage, thereby the storage administrator can install additional storage devices before a performance problem occurs.

An aspect of the present invention provides a storage system including one or more storage nodes having one or more processors and storage devices storing data. A first storage device and a second storage device having different performances are included in the storage system. The processor manages a volume having a storage region to which the storage device is allocated and performs an input/output of data for the storage device via the volume. The processor calculates an input/output frequency relating to the input or/and the output of the data for each storage region and manages volume configuration relating to an allocation amount of each of the first and second storage devices to the volume. A management unit acquires the input/output frequency from the processor and generates distribution information of the input/output frequency for each volume. The management unit determines performance of the volume on the basis of the distribution information of the input/output frequency in the volume and the volume configuration of the storage device of each performance to the volume.

According to the present invention, a shortage of high-performance storage devices can be detected by the storage system for performing priority control for each type of volumes.

### BRIEF DESCRIPTION OF THE DRAWINGS

FIG. 1 is a block diagram showing an example of a storage system in a first embodiment of the present invention;

FIG. 2 is a block diagram showing an example of a storage node in the first embodiment of the present invention;

FIG. 3 is a block diagram showing an example of a management node in the first embodiment of the present invention;

FIG. 4 is a block diagram showing a relation between a global pool and a local pool in the first embodiment of the present invention;

FIG. 5 is a diagram showing an example of a priority management table in the first embodiment of the present invention;

FIG. 6 is a diagram showing an example of a configuration of a global node table in the first embodiment of the present invention;

FIG. 7 is a diagram showing an example of a global volume table in the first embodiment of the present invention;

FIG. 8 is a diagram showing an example of a configuration of a global chunk control table in the first embodiment of the present invention;

FIG. 9 is a diagram showing an example of a configuration of a global tiering table in the first embodiment of the present invention;

FIG. 10 is a diagram showing an example of a configuration of a local volume management table in the first embodiment of the present invention;

FIG. 11 is a diagram showing an example of a configuration of a local tier control table in the first embodiment of the present invention;

FIG. 12 is a diagram showing an example of a configuration of a volume page control table in the first embodiment of the present invention;

FIG. 13 is a diagram showing an example of a configuration of a physical page control table in the first embodiment of the present invention;

FIG. 14 is a diagram showing an example of a configuration of a monitor information collection table in the first embodiment of the present invention;

FIG. 15 is a diagram showing an example of a configuration of a global IO frequency distribution table in the first embodiment of the present invention;

FIG. 16 is a diagram showing an example of a configuration of a global used capacity table in the first embodiment of the present invention;

FIG. 17 is a flowchart showing an example of processing performed by a management node in the first embodiment of the present invention;

FIG. 18 is a flowchart showing an example of global tier 1 capacity shortage determination processing in the first embodiment of the present invention;

FIG. 19 is a flow chart showing an example of volume owner node selection processing performed by a management node in the first embodiment of the present invention;

FIG. 20 is a flowchart showing an example of chunk allocation processing performed by a management node in the first embodiment of the present invention;

FIG. 21 is a diagram showing an example of a volume management GUI in the first embodiment of the present invention;

FIG. 22 is a diagram showing an example of a volume addition GUI in the first embodiment of the present invention;

FIG. 23 is a diagram showing an example of a node addition GUI in the first embodiment of the present invention;

FIG. 24 is a block diagram showing an example of a management node in a second embodiment of the present invention;

FIG. 25 is a block diagram showing an example of a local pool in the second embodiment of the present invention;

FIG. 26 is a block diagram showing a relation between a global pool and a local pool in a third embodiment of the present invention;

FIG. 27 is a diagram showing an example of a configuration of a local pool IO frequency distribution table in the first embodiment of the present invention; and

FIG. 28 is a flowchart showing an example of global tier 1 capacity shortage determination processing in the third embodiment of the present invention.

### DESCRIPTION OF THE PREFERRED EMBODIMENTS

Embodiments of the present invention will be described below on the basis of the accompanying drawings.

### First Embodiment

### System Configuration

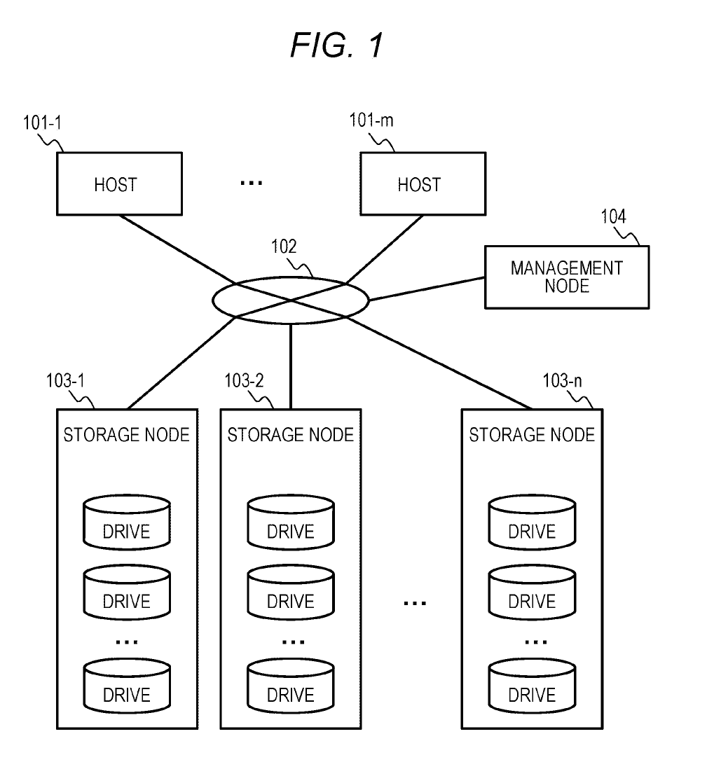

FIG. 1 a block diagram showing an example of a storage system in a first embodiment of the present invention. The first embodiment shows an example of the application of the present invention for performing priority control for different types of volumes in a storage system consisting of storage devices with different performances.

Storage nodes 103-1 to 103-n having storage devices with different performances, a management node 104 managing a large number of storage nodes 103-1 to 103-n, and hosts 101-1 to 101-m using storage regions of the storage nodes 103-1 to 103-n are connected via a network 102.

In the following description, when each storage node is not specified, the storage node is denoted simply by reference numeral 103. The same is applied to reference numerals of the other components.

The management node 104 manages a large number of storage nodes 103 having local pools and a global pool across the storage nodes 103. The management node 104 provides volumes having different performances to the hosts 101.

The local pool is a storage pool internally managed by the storage node 103 and includes a plurality of tiers according to performance characteristics. In addition, the global pool is a storage pool of storage devices across nodes and allocates a physical capacity of the storage devices to the local pool. The management node 104 controls allocation of resources (chunks) of the global pool to each tier of the local pool. A user of the host 101 using the storage node 103 can use the volume without being conscious of the physical configuration of the storage nodes 103.

### Storage Node

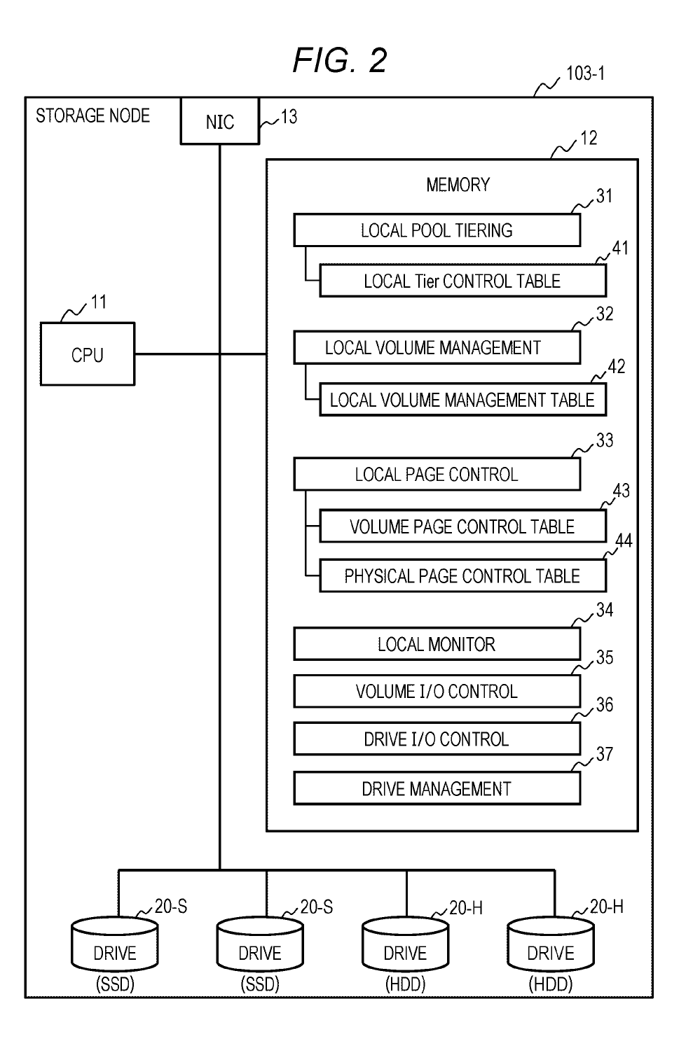

FIG. 2 is a block diagram showing an example of the storage node 103. The storage node 103 is a computer that includes one or more CPU 11, one or more memory devices 12, one or more network interface (NIC in the drawing) 13, one or more drives 20-S functioning as storage devices, and one or more drives 20-H functioning as storage devices and provides volumes to the host 101.

The drive 20-S is a high-performance storage device having higher performance than the drive 20-H and is composed of a nonvolatile semiconductor memory such as a solid state drive (SSD), for example. The drive 20-S is a drive that has performance in which IOPS is higher than that of the drive 20-H and a sequential read speed is higher than that of the drive 20-H.

On the other hand, the drive 20-H is a storage device that has lower performance than the drive 20-S, but has low cost per bit and high cost performance and is composed of a hard disk drive (HDD), for example.

The network interface 13 is connected to the network 102 and communicates with the host 101, the management node 104, or other storage node 103.

Respective functional units of a local pool tiering 31, a local volume management 32, a local page control 33, a local monitor 34, a volume I/O control 35, and a drive management 37 are loaded as programs on the memory 12 and are executed by the CPU 11.

The CPU 11 operates as a functional unit that provides a predetermined function by executing processing according to the program of each functional unit. For example, the CPU 11 functions as the local pool tiering 31 by executing processing according to the local pool tiering program. The same is applied to the other programs. Also, the CPU 11 operates as a functional unit that provides a function of each of a plurality of processing executed by each program. A computer and a computer system are a device and a system including these functional units.

Information such as programs and tables for realizing the respective functions of the storage node 103 can be stored in a memory device such as a storage device, a nonvolatile semiconductor memory, a hard disk drive, and an SSD or a computer readable non-transitory data storage medium such as an IC card, an SD card, and a DVD.

The local pool tiering 31 is a functional unit that manages a configuration for each tier of a local pool of the storage node 103, and manages chunks allocated to each tier on the basis of a local tier control table 41. The pool and the tier will be described later.

The local pool tiering 31 acquires a state of a local pool 26 at a predetermined cycle and updates the local tier control table 41. Further, if a usage ratio (for example, allocated page capacity 414/total chunk capacity 413) of a local tier 27 is equal to or more than a predetermined threshold Th4 (for example, 90%), the local pool tiering 31 send the notification of the shortage of the chunk capacity to the management node 104. The monitoring of the usage ratio of the local tier 27 is performed for each of local tiers 27-1 to 27-3. The notifications of the capacity shortage include a type of the storage node 103.

The local volume management 32 is a functional unit that manages a volume provided by the storage node 103 to the host 101, by referring to the local volume management table 42. The local page control 33 is a functional unit that manages a correspondence relation between physical pages on a logical page (data management unit of a local pool in the storage node 103) constituting a volume and a physical page on a chunk (data management unit of the global pool across nodes), by referring to a volume page control table 43 and a physical page control table 44.

The local monitor 34 is a functional unit that monitors resources possessed by the storage node 103 and collects statistical information. The local monitor 34 transmits the statistical information to the global monitor 65, according to a request from the global monitor 65 of the management node 104. The first embodiment shows an example in which an IO count (IOPS or IOPH) that is statistical information indicating performance of a volume 200 is used as statistical information collected by the local monitor 34. However, the present invention is not limited thereto. For example, statistical information showing performance such as a read/write speed (MB/sec) of the volume 200 can be used.

The volume I/O control 35 is a functional unit that processes commands such as read from and writes to the volume which is provided by the storage node 103 to the host 101. The drive I/O control 36 is a functional unit that processes commands such as read and write with respect to the drives 20-S and 20-H in the storage node 103.

Tables that are loaded on the memory 12 and are used by each functional unit will be described later.

### Management Node

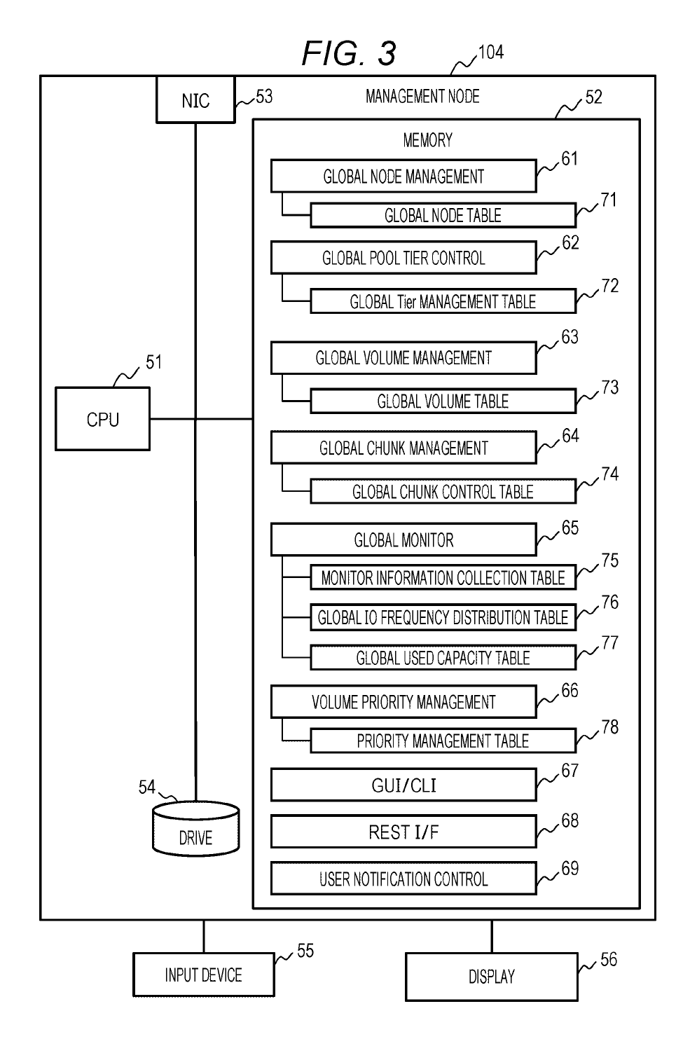

FIG. 3 is a block diagram showing an example of the management node 104. The management node 104 is a computer that includes one or more CPU 51, one or more memory devices 52, one or more network interface (NIC in the drawing) 53, one or more drives 54 functioning as one or more storage devices, an input device 55, and a display 56 and manages the storage node 103. The management node 104 does not have to be an independent node but may be a function of a storage node and may manage the storage system from the outside of the storage system.

The network interface 53 is connected to the network 102 and communicates with the host 101 or the storage node 103. The input device 55 includes a keyboard, a mouse, and a touch panel and accepts an operation from a user (or a storage administrator). On the display 56, a screen of a management interface and the like are displayed.

Respective functional units of a global node management 61, a global pool tier control 62, a global volume management 63, a global chunk management 64, a global monitor 65, a volume priority management 66, a GUI/CLI 67, an REST I/F 68, and a user notification control 69 are loaded as programs on the memory 52 and are executed by the CPU 51.

The CPU 51 operates as a functional unit that provides a predetermined function by executing processing according to the program of each functional unit. For example, the CPU 51 functions as the global node management 61 by executing processing according to the global node management program. The same is applied to the other programs. Also, the CPU 51 operates as a functional unit that provides a function of each of a plurality of processing executed by the respective programs. A computer and a computer system are a device and a system including these functional units.

Information such as programs and tables for realizing the respective functions of the management node 104 can be stored in a memory device such as a storage device (drive 54), a nonvolatile semiconductor memory, a hard disk drive, and an SSD or a computer readable non-transitory data storage medium such as an IC card, an SD card, and a DVD.

The global node management 61 manages the storage node 103 by referring to a global node table 71. The global pool tier control 62 is a functional unit that manages tiers of chunks allocated to the local pool, by referring to a global tiering table 72.

The global volume management 63 is a functional unit that manages host volumes created from the global pool by a global volume table 73. The global chunk management 64 is a functional unit that manages chunks of the global pool (data management units in the global pool) on the basis of a global chunk control table 74.

The global monitor 65 is a functional unit that stores the information of the local monitor 34 of the storage node 103 in a monitor information collection table 75 and updates a global IO frequency distribution table 76 and a global used capacity table 77.

The volume priority management 66 is a functional unit that manages priority for each type of volumes provided by each storage node 103, by referring to a priority management table 78. The GUI/CLI 67 is a functional unit that provides a management interface as a graphical user interface (GUI) or a command line interface (CLI).

The REST I/F 68 is a functional unit that communicates with the host 101, the storage node 103, or the like in a REST format. The user notification control 69 is a functional unit that issues notifications to the display 56 or the like at the time of entering a predetermined state such as shortage of a capacity and occurrence of a failure.

Tables that are loaded on the memory 52 and are used by each functional unit will be described later. Further, a drive 20 may have a RAID configuration.

### Configuration of Pool

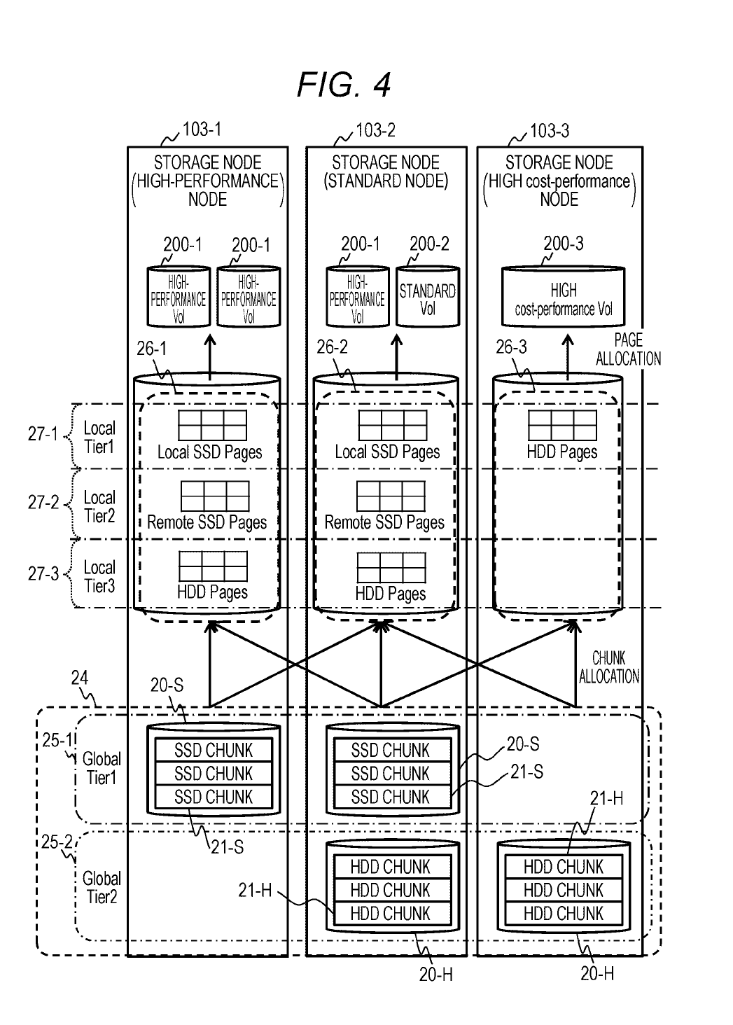

FIG. 4 is a block diagram showing a relation between the global pool and the local pool. In the present embodiment, a storage pool across the three storage nodes 103-1 to 103-3 with the drives 20 having different performances is set as a global pool and the storage nodes 103-1 to 103-3 are operated as nodes having different performances (or types).

In the example shown in the drawing, the storage node 103-1 functions as a high-performance node that provides a plurality of high-performance volumes (high-performance VOLs in the drawing) 200-1. The storage node 103-2 functions as a standard node that provides the high-performance volume 200-1 and a standard-performance volume (standard VOL in the drawing) 200-2. In addition, the storage node 103-3 functions as a high cost-performance node that provides a high cost-performance volume (high cost-performance VOL in the drawing) 200-3 having low cost per bit.

The present embodiment provides an example in which the storage nodes 103 are classified into three types: high performance, standard, and high cost performance. However, the present invention is not limited thereto and a plurality of types of performances may be used. The type of the storage node 103 is determined by the management node 104 according to a command of the storage administrator.

In the first embodiment, the priority control of the volume 200 is performed by the high-performance drive 20-S and the high cost-performance drive 20-H providing chunks 21 to the plurality of storage nodes 103.

The high-performance volume 200-1 is preferentially allocated to the high-performance node (storage node 103-1), and the high-performance chunk 21-S is preferentially allocated to the high-performance volume 200-1. The standard node (storage node 103-2) has a priority of allocation of the high-performance volume 200-1 lower than that of the high-performance node. Further, for the standard volume 200-2, priority of allocation of the high-performance chunk 21-S is set low.

The high-performance drive 20-S such as the SSD is mounted as a storage device in the storage node 103-1 to be the high-performance node. The drive 20-S such as the SSD and a drive 20-H such as the HDD are mounted as a storage device in the storage node 103-2 to be the standard node. The drive 20-H such as the HDD is mounted as a storage device in the storage node 103-3 to be the high cost-performance node. In the present embodiment, the performances of the drives are classified into two levels. However, the performance may be classified finely within the SSD or the HDD. Further, the performance may be distinguished according to whether it is within an own node or another node as seen from a volume.

In the storage node 103-1 to be the high-performance node, higher-performance CPUs 11 and the larger-capacity memory 12 may be mounted than those of the storage node 103-2 to be the standard node. Further, in the storage node 103-3 to be the high cost-performance node, the low-cost CPU 11 and the minimum-capacity memory 12 may be mounted as compared with the standard node.

The management node 104 allocates the drives 20 mounted in the storage nodes 103-1 to 103-3 providing the storage regions to the host 101 to a global pool 24. In addition, two tiers (groups) of a global tier 1 (25-1) composed of the high-performance drive 20-S and a global tier 2 (25-2) composed of the drive 20-H with a low price per bit are set to the global pool 24.

The management node 104 manages the storage region of the drive 20 allocated to the global pool 24 in units of chunks of a predetermined size (for example, 100 GB). That is, the management node 104 manages the storage region of the drive 20-S allocated to the global tier 1 (25-1) in units of the chunks 21-S. Similarly, the management node 104 manages the storage region of the drive 20-H allocated to the global tier 2 (25-2) in units of chunks 21-H.

The management node 104 configures local pools 26-1 to 26-3 to the storage nodes 103-1 to 103-3, respectively. Then, the management node 104 allocates the chunks 21-S or the chunks 21-H from the global tier 1 (25-1) and the global tier 2 (25-2) of the global pool 24 to the local pools 26-1 to 26-3, respectively, according to types of the storage nodes 103.

Each storage node 103 manages the chunk 21 allocated to the local pool 26 as a physical page of a predetermined capacity (for example, 42 MB). The storage node 103 manages the volume 200 and divides the logical block address (LBA) of the volume 200 into logical pages of predetermined capacities (for example, 42 MB).

Each storage node 103 manages the local pool 26 and divides the local pool 26 into the local tier 1 (27-1), the local tier 2 (27-2), and the local tier 3 (27-3), according to a performance difference (type) of the allocated chunks 21.

The configurations of the local tier 1 to the local tier 3 are determined for each type of drive 20 corresponding to the chunk 21-S.

The local tier 1 (27-1) includes pages (local SSD pages) allocated to the chunks 21-S of the high-performance drives 20-S in the same storage node 103. The local tier 2 (27-2) is the high-performance drive 20-S, but includes pages allocated to the chunks 21-S of other storage node 103 (remote SSD pages).

The local tier 3 (27-3) includes pages allocated to the chunks 21-H of the drives 20-H with a low price per bit (HDD pages). The HDD pages of the local tier 3 (27-3) may be pages including the chunks 21-H of the HDD, regardless of an own node or other node.

At the time of first write to the logical page, each storage node 103 sets a correspondence relation between the logical page allocated to the physical page of the local pool 26 and the physical page to the volume page control table 43. The storage node 103 uses it for the following data read and write.

The allocation of the chunks 21 to the local pool 26 is performed at predetermined timing such as when the capacity of the storage node 103 is insufficient. For example, if a percentage of a capacity of the allocated pages of the local tier 1 (27-1) at the high-performance node exceeds 80% of a total capacity of the local tier 1 (27-1), the management node 104 allocates a new chunk 21-S from the global tier 1 (25-1).

In the storage node 103-1 of the high-performance node, the high-performance volume 200-1 is created with the logical pages of the local tier 1 (27-1) and is provided to the host 101. In the storage node 103-2 of the standard node, the high-performance volume 200-1 is created with the logical pages of the local tier 1 (27-1) and the standard volume 200-2 is created with the logical pages of the local tier 2 (27-2) are provided to the host 101.

In the storage node 103-3 of the high cost-performance node, the high cost-performance volume 200-3 is created with the logical pages of the local tier 3 (27-3) and is provided to the host 101.

The storage node 103 rebalances (data-copies) the physical pages allocated to the logical pages among the local tier 1 to the local tier 3, depending on the access frequency of the logical page constituting the volume 200.

The configurations of the global pool 24 and the local pool 26 are not limited to the above example. For example, the volume 200 may be created from the global pool 24 directly, without setting the local pool to the storage node 103. In this case, the management unit of the storage region of the global pool 24 may manages the pages instead of chunks and the pages may be assigned to the storage node 103.

Further, the capacity (size) of the page and the capacity of the chunk are not limited to the above example and may be set to a desired size or a variable length. In the first embodiment, the chunk 21 of the global pool 24 is allocated directly to the storage node 103. However, the present invention is not limited thereto. For example, a configuration in which two or more chunks subjected to redundancy (replication or erasure correction coding) are allocated as one chunk to the storage node may be used.

### Configuration of Table

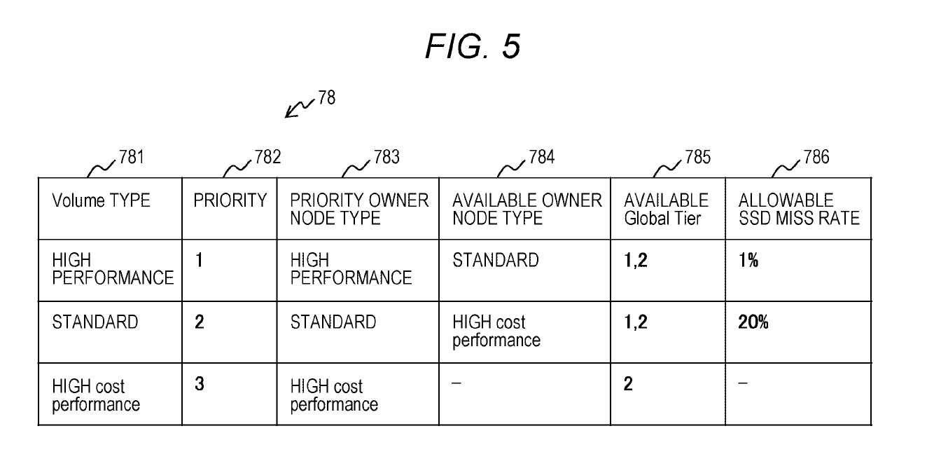

FIG. 5 is a diagram showing an example of the priority management table 78. The priority management table 78 is used in the volume priority management 66 of the management node 104.

The priority management table 78 includes a volume type 781, a priority 782, a priority owner node type 783, an available owner node type 784, an available global tier 785, and an allowable SSD miss ratio 786 in one entry.

In the volume type 781, any one of “high performance”, “standard”, and “high cost performance” is preset.

The “high performance” indicates a high-performance volume 200-1 to which the high-performance drives 20-S are preferentially assigned with performance emphasis. The “standard” indicates the standard-performance volume 200-2 that uses the pages of the high-performance drive 20-S when the pages remain unused and uses the pages of the drive 20-H with a low cost per bit otherwise. The “high cost performance” indicates the high cost-performance volume 200-3 that always uses the pages of the drive 20-H with low cost per bit.

The standard-performance volume 200-2 uses the pages of the local SSD of the local tier 1 when the pages of the local tier 1 remain unused in the local pool 26, uses the page of the remote SSD of the local tier 2 when there are no pages in the local tier 1 and the pages of the local tier 2 remain unused, and uses the pages of the HDD of the local tier 3 when there are no pages even in local tier 2.

The stores priority 782, the order in which the high-performance drives 20-S are preferentially allocated. Smaller value means higher priority.

The priority owner node type 783 stores the default type of the storage nodes 103 to which the volume 200 of the volume types 781 of the entry concerned is assigned . Similar to the volume type 781, any one of three types of “high performance”, “standard”, and “high cost performance” is set as the type of the storage node 103.

The available owner node type 784 stores the type of the storage nodes 103 that is available when the storage node 103 of the type designated by the priority owner node type 783 is unavailable. For example, when the number of remaining pages of the local SSD is insufficient and the high-performance volume 200-1 cannot be created, the node type of the available owner node type 784 is substituted for the node of the designated type of nodes.

The available global tier 785 stores the global tiers of the global pool 24. The global tiers can provide the chunk 21 to be allocated to the volume type 781 of the entry.

In the allowable SSD miss ratio 786, the allowable miss ratio of the SSD for each volume type 781 is preset. The miss ratio of the SSD indicates a ratio (SSD miss ratio to be described later) of cases where the host 101 cannot access the page of the high-performance drive 20-S with respect to cases where the host 101 performs read or write to the volume 200. When the ratio exceeds a value of the allowable SSD miss ratio 786, the management node 104 notifies the user (or the storage administrator) that the ratio exceeds the value. In the first embodiment, the pre-defined values of the system are used. However, the user (or the storage administrator) may set the pre-defined by the GUI/CLI 67 or the REST I/F 68.

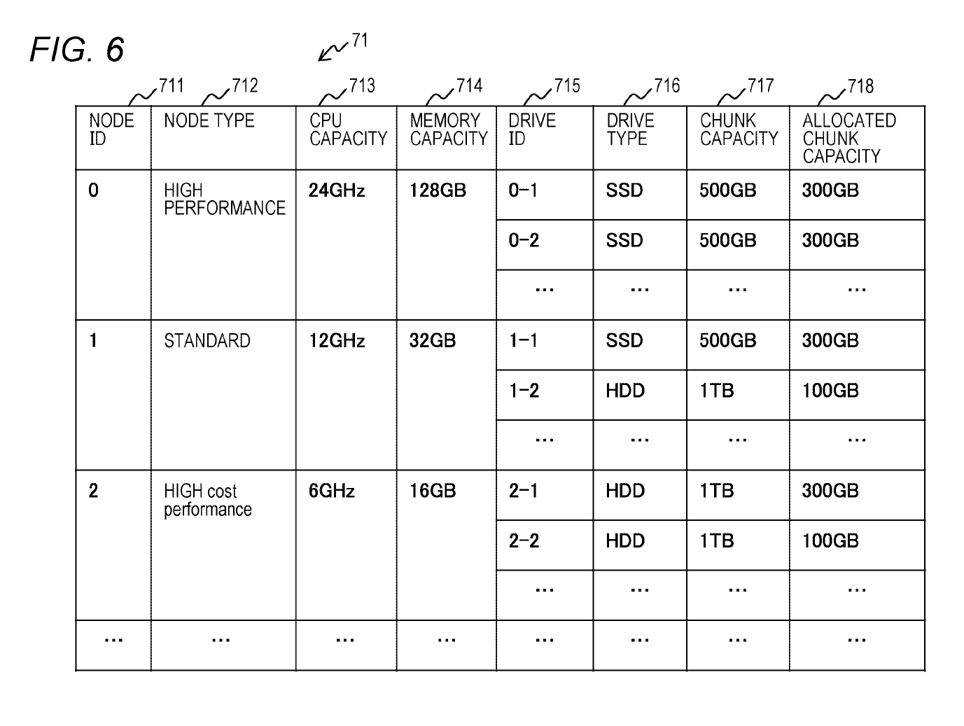

FIG. 6 is a diagram showing an example of a configuration of the global node table 71. The global node table 71 is a management table of the storage node 103 referred to by the global node management 61.

The global node table 71 includes a node ID 711, a node type 712, a CPU capacity 713, a memory capacity 714, a drive ID 715, a drive type 716, a chunk capacity 717, and an allocated chunk capacity 718 in one entry.

In the node ID 711, an identifier of the storage node 103 to be managed is stored. The identifier is a unique value in the global pool 24. The node type 712 stores a type of the storage node 103. In the present embodiment, any one of “high performance”, “standard”, and “high cost performance” is used.

In the CPU capacity 713, a value corresponding to a processing capacity of the CPU 11 in the storage node 103, for example, frequency multiplied by CPU core number is stored. In the memory capacity 714, a capacity of the memory 12 mounted in the storage node 103 is stored.

In the drive ID 715, an identifier of the physical drive 20 mounted in the storage node 103 is stored. In the drive ID 715, a unique value in the global pool is used.

In the drive type 716, a type of the drive 20 is stored. In the present embodiment, either the SSD or the HDD is set as the type. In the chunk capacity 717, a total capacity of chunks for each drive 20 is stored. In the allocated chunk capacity 718, a chunk capacity allocated to the local pool 26 for each drive 20 is stored.

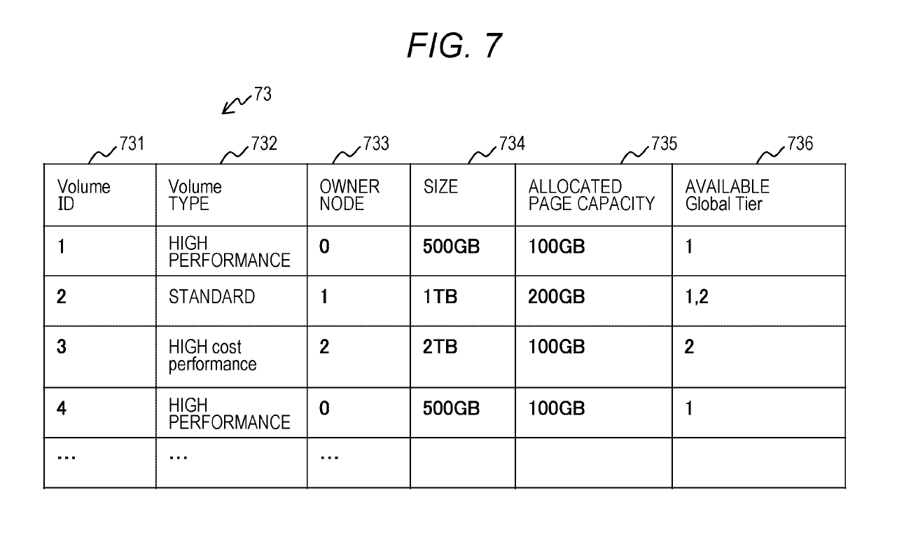

FIG. 7 is a diagram showing an example of a configuration of the global volume table 73. The global volume table 73 is a management table for managing of all volumes of the local pool used by the global volume management 63 of the management node 104.

The global volume table 73 includes a volume ID 731, a volume type 732, an owner node 733, a size 734, an allocated page capacity 735, and an available global tier 736 in one entry.

In the volume ID 731, an identifier of the volume 200 is stored. The identifier is a unique value in the global pool 24. In the volume type 732, a type of the volume 200 is set. In the first embodiment, any one of “high performance”, “standard”, and “high cost performance” is used.

In the owner node 733, an identifier of the storage node 103 that creates the volume 200 is stored. In the size 734, a logical size of the volume is stored. In the case of a thin provisioning volume, the stored value might be larger than a physical storage capacity.

The allocated page capacity 735 stores a capacity of the logical page to which the physical storage capacity is allocated. In the available global tier 736, a value of the global tier 25 available by the volume is stored. The global tier 25 might store several values. The value of the global tier 25 is determined according to the volume type 732.

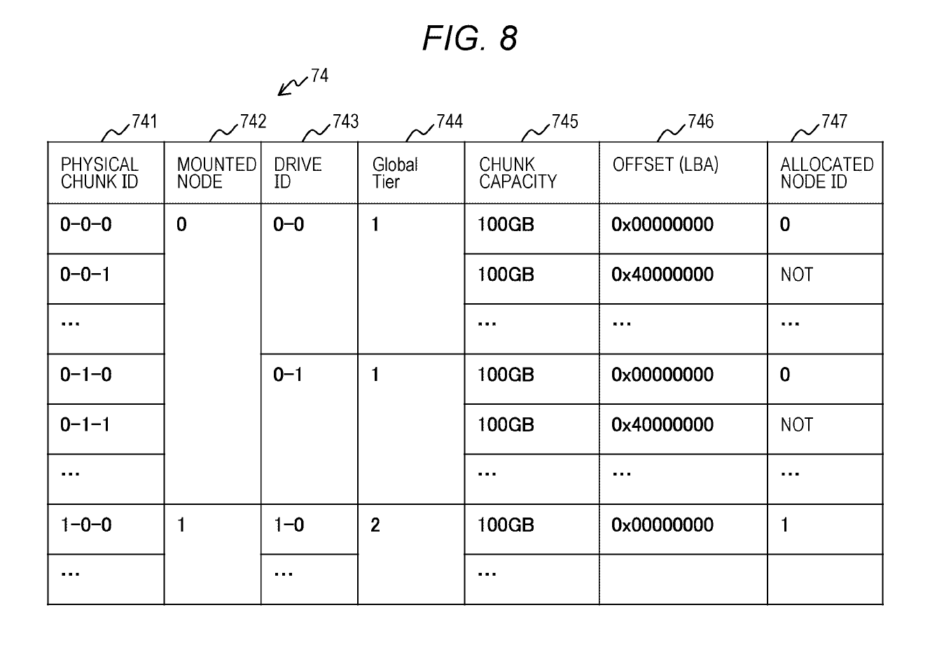

FIG. 8 is a diagram showing an example of a configuration of the global chunk control table 74. The global chunk control table 74 manages all chunks 21 of the global pool 24 to be used by the global chunk management 64 of the management node 104.

The global chunk control table 74 includes a physical chunk ID 741, a mounted node 742, a drive ID 743, a global tier 744, a chunk capacity 745, an offset (LBA) 746, and an allocated node ID 747 in one entry.

In the physical chunk ID 741, an identifier of the physical chunk 21 to be managed is stored. As the identifier of the physical chunk 21, a value that can be uniquely identified in the global pool 24 is set by the management node 104. The mounted node 742 stores an identifier of the storage node 103 that mounts the physical chunk 21 to be managed.

The drive ID 743 stores an identifier of the drive 20 in which the physical chunk 21 to be managed is stored. In the global tier 744, a value of the global tier 25 to which the drive 20 belongs is stored. In the chunk capacity 745, a capacity of the physical chunk is stored. The first embodiment shows an example in which the capacity of one chunk 21 is set to 100 GB.

In the offset 746, a starting logical block address (LBA) of a storage region of the physical chunk in the drive 20 is stored. In the allocated node ID 747, an identifier of the storage node 103 to which the physical chunk 21 to be managed is allocated is stored. If the chunk 21 is not allocated, “not” is set.

The global chunk control table 74 defines the storage node 103 of the allocation destination of the chunk 21, the storage node 103 generating the chunk 21, the drive 20, and a start position.

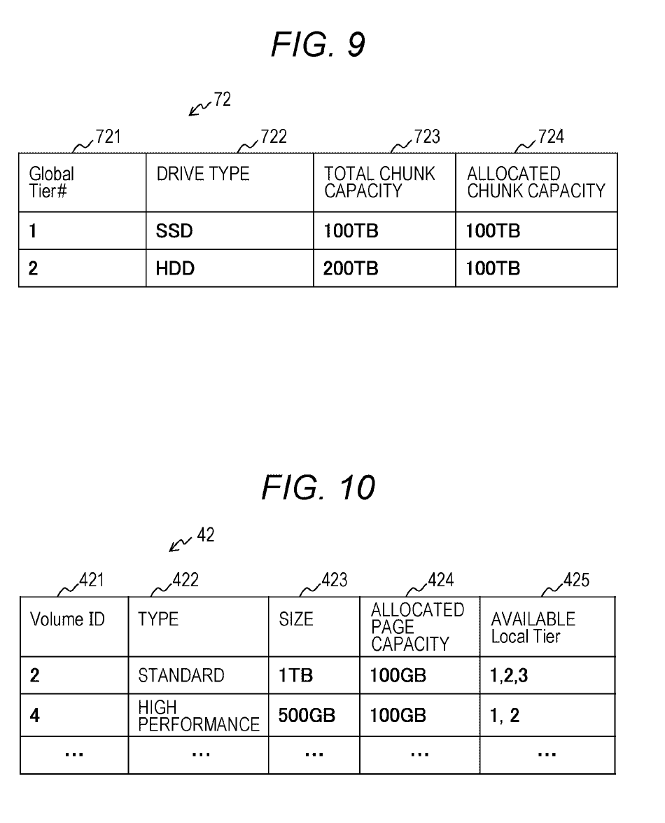

FIG. 9 is a diagram showing an example of a configuration of the global tiering table 72. The global tiering table 72 is used by the global pool tier control 62 of the management node 104.

In a global tier no. 721, a tier number of the global tier 25 to be managed is stored. In a drive type 722, a type of the drive 20 included in the global tier 2 is stored. In the present embodiment, either the SSD or the HDD is stored as described above.

In a total chunk capacity 723, a total chunk capacity in the global tier 25 is stored. In an allocated chunk capacity 724, a chunk capacity allocated to the local pool 26 is stored.

FIG. 10 is a diagram showing an example of a configuration of the local volume management table 42. The local volume management table 42 is a table in which the local monitor 34 and the local volume management 32 of the storage node 103 manage the volumes in the node.

In a volume ID 421, an identifier of the volume to be managed is stored. As the identifier, a unique value in the global pool 24 is used. In a type 422, any one of “high performance”, “standard”, and “high cost performance” is preset, similar to the volume type 781 of the priority management table 78.

In a size 423, a logical size of the volume is stored. In the case of a thin provisioning volume, a stored value might be larger than the used physical storage capacity.

In an allocated page capacity 424, a capacity of the logical page to which the physical storage capacity is allocated is stored. The available local tier 425 stores local tiers 27 available for the volume. Several ties can be used for the local tier 27. The value of the local tier 27 is determined according to the type 422 of the volume.

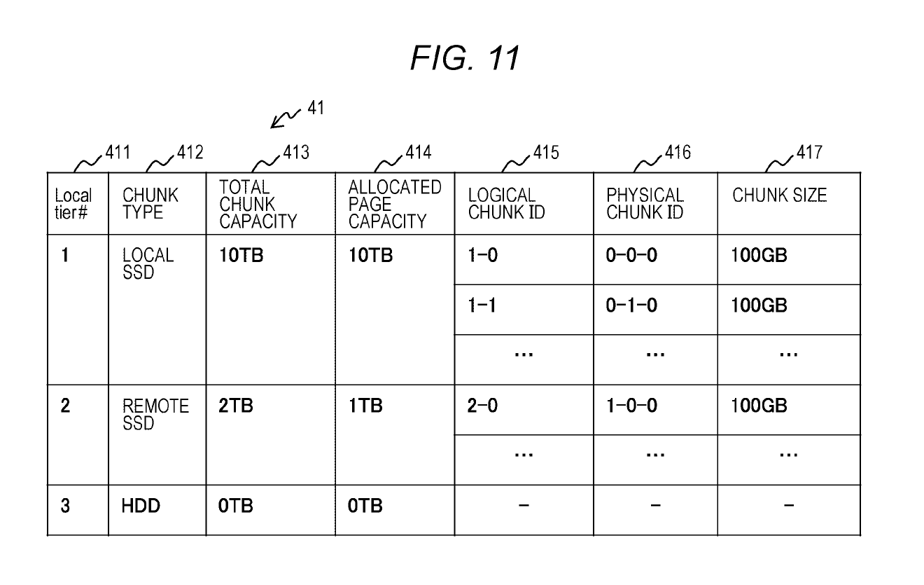

FIG. 11 is a diagram showing an example of a configuration of the local tier control table 41. The local tier control table is managed by the local pool tiering 31 of the storage node 103.

The local tier control table 41 includes a local tier no. 411, a chunk type 412, a total chunk capacity 413, an allocated page capacity 414, a logical chunk ID 415, a physical chunk ID 416, and a chunk size 417 in one entry.

In the local tier no. 411, a value (tier) of the local tier 27 to be managed is stored. In the chunk type 412, a type of chunk that has provided a page is stored. In the present embodiment, any one of “local SSD”, “remote SSD”, and “HDD” is set as the chunk type.

In the total chunk capacity 413, a capacity of the chunks allocated to the local tier 27 is stored. The allocated page capacity 414 stores a capacity of the pages which is allocated from the chunks in the local tier 27. In the logical chunk ID 415, a logical chunk ID in the local tier 27 is stored. In the physical chunk ID 416, an ID of the physical chunk 21 in which the logical chunk is actually stored is stored. In the chunk size 417, a size of the chunk 21 is stored.

By separating and managing the logical chunk and the physical chunk in the local tier control table 41, rebalancing of the chunk 21 can be performed by rewriting the ID of the physical chunk corresponding to the logical chunk in the storage node 103.

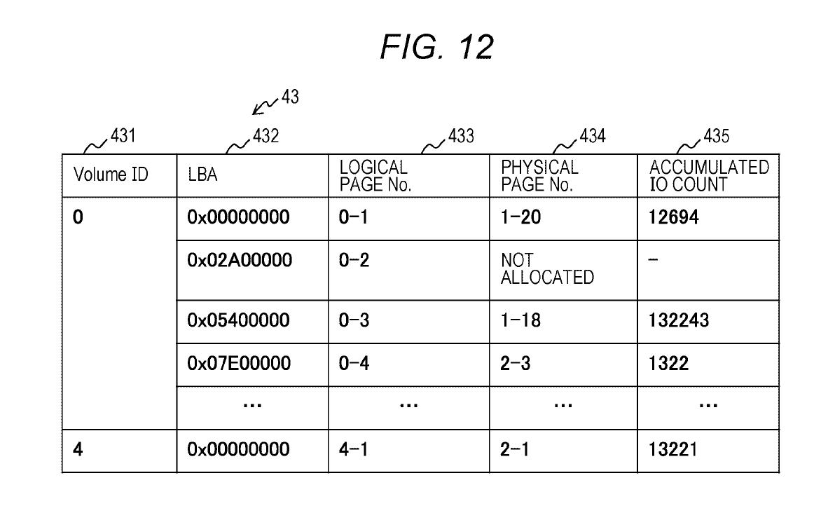

FIG. 12 is a diagram showing an example of a configuration of the volume page control table 43. The volume page control table 43 is a control table of logical pages for each volume 200 managed by the local page control 33 of the storage node 103.

The volume page control table 43 includes a volume ID 431, an LBA 432, a logical page no. 433, a physical page no. 434, and an accumulated IO count 435 in one entry.

In the volume ID 431, an identifier of the volume 200 is stored. The identifier is a unique value in the global pool 24. In the LBA 432, an LBA in the volume 200 is stored.

In the logical page no. 433, a number of the logical pages allocated to the LBA 432 is stored. In the physical page no. 434, a number of the physical pages corresponding to the logical page no. 433 is stored. As a value of the physical page no. 434, a unique value in the local pool 26 is used. In addition, “not allocated” is stored when the physical page is not allocated to a logical page.

In the accumulated IO count 435, an accumulated value of IO count for the logical page is stored. The accumulated value of the IO count may be reset at a predetermined interval (for example, one hour). In the first embodiment, an example in which the IO count is used as the statistical information for measuring the performance of the volume 200 is shown. However, the present invention is not limited thereto. For example, a read/write speed of the volume 200, the number of bytes of read/written data, or the like may be used.

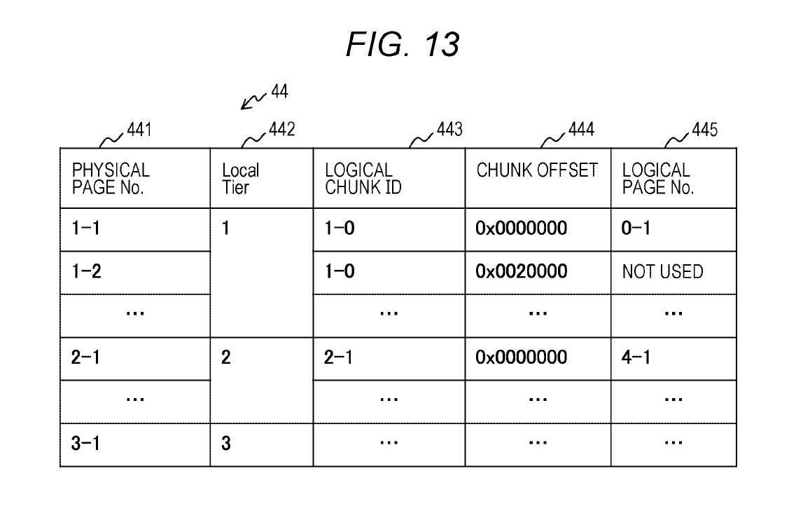

FIG. 13 is a diagram showing an example of a configuration of the physical page control table 44. The physical page control table 44 is a control table of a physical page to be used by the local page control 33 of the storage node 103.

The physical page control table 44 includes a physical page no. 441, a local tier 442, a logical chunk ID 443, a chunk offset 444, and a logical page no. 445 in one entry.

In the physical page no. 441, the number of the physical pages is stored. The local tier 442 stores the value (tier) of the local tier 27 in which the physical page has been stored. The local tier 27 is in the local pool 26. In the logical chunk ID 443, an identifier of the chunk 21 in which the physical page has been stored is stored.

The chunk offset 444 stores the offset of the data region, in which the physical page has been stored, in the chunk 21. In the logical page no. 445, a number of the logical page to which the physical page has been allocated is stored. When the physical page is not allocated, “not used” is stored.

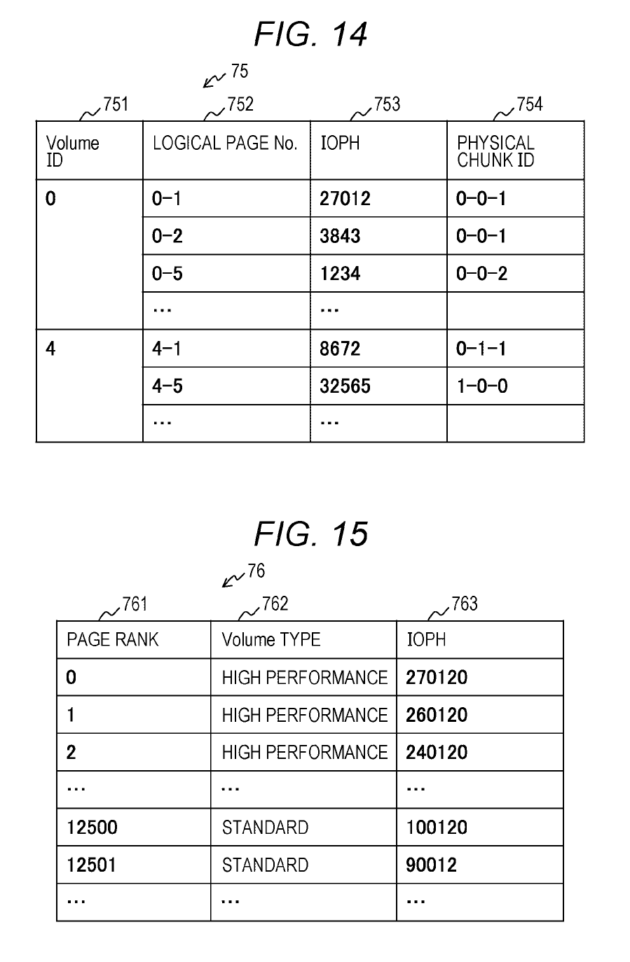

FIG. 14 is a diagram showing an example of a configuration of the monitor information collection table 75. In the monitor information collection table 75, the global monitor 65 of the management node 104 stores monitor information collected regularly (for example, every hour) from the local monitor 34 of each storage node 103.

The monitor information collection table 75 includes a volume ID 751, a logical page no. 752, an IOPH 753, and a physical chunk ID 754 in one entry. In the volume ID 751, an identifier of the volume 200 is stored. The identifier is a unique value in the global pool 24.

In the logical page no. 752, a number of the logical page allocated to the LBA 432 is stored. In the IOPH (IO per hour) 753, an IO count per hour for the logical page is stored. In the physical chunk ID 754, a number of the physical chunk allocated to the logical page is stored.

The global monitor 65 of the management node 104 collects the monitor information from the local monitor 34 of each storage node 103 at a predetermined interval (for example, one hour) and updates the monitor information collection table 75 with the logical page no. as a key.

When the accumulated IO count 435 of the volume page control table 43 is an actual accumulated value of IO counts, the global monitor 65 may calculate the IOPH 753 on the basis of a difference with a previous value. If the accumulated value of the accumulated IO count 435 is an IO count per hour, it can be set to IOPH 753 as it is.

FIG. 15 is a diagram showing an example of a configuration of the global IO frequency distribution table 76. The global IO frequency distribution table 76 is a table in which the global monitor 65 of the management node 104 manages a distribution of an IO frequency of the entire global pool 24 in a page unit.

The global IO frequency distribution table 76 includes a page rank 761, a volume type 762, and an IOPH 763 in one entry. In the page rank 761, a rank of the IOPH of the logical page is stored. In the present embodiment, an example in which the rank is set in descending order with the logical page with the maximum IOPH as the first logical page is shown.

In the volume type 762, the type 422 of the volume 200 constituting the logical page corresponding to the rank is stored. In the IOPH, the IOPH 763 of the logical page corresponding to the rank is stored.

A field of the logical page no. may be added to the global IO frequency distribution table 76 so that the volume 200 can be easily specified.

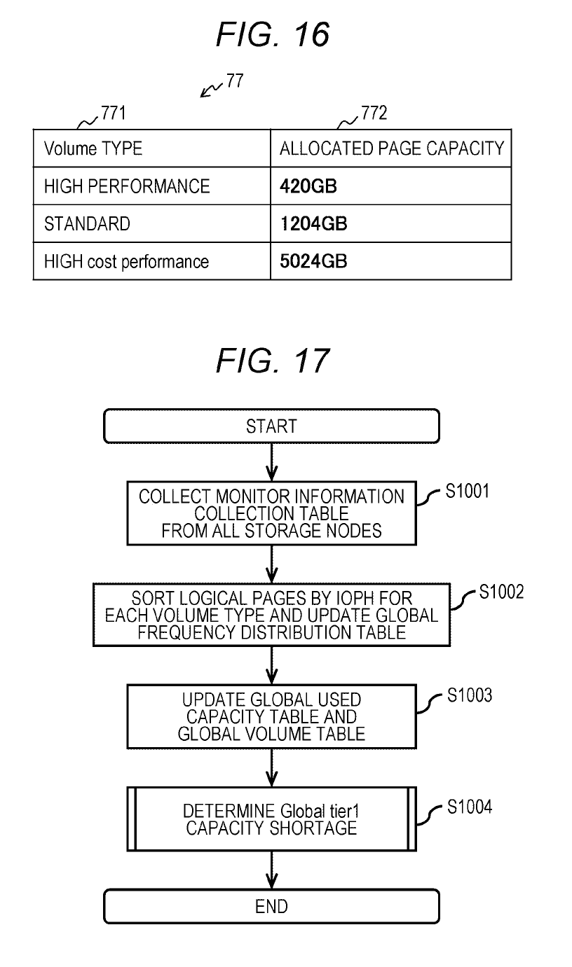

FIG. 16 is a diagram showing an example of a configuration of the global used capacity table 77. The global used capacity table 77 manages the capacity used by the global monitor 65 of the management node 104 for each volume type of the global pool 24.

The global used capacity table 77 includes a volume type 771 and an allocated page capacity 772 in one entry. In the volume type 771, a type of the volume 200 to be provided by the storage node 103 is stored. In the present embodiment, three types of “high performance”, “standard”, and “high cost performance” are used.

In the allocated page capacity 772, a total of pages allocated for each type of volume 200 calculated by the global monitor 65 is stored.

The table of the storage node 103 may be updated by the local monitor 34 at a predetermined cycle, in addition to being managed by each functional unit.

### Processing

FIG. 17 is a flowchart showing an example of processing performed by the management node 104. The flowchart is executed by the management node 104 at a predetermined cycle (for example, one hour).

In step S1001, the global monitor 65 of the management node 104 acquires the statistical information from the local monitors 34 of all storage nodes 103 constituting the global pool 24 and updates the monitor information collection table 75.

Specifically, the local monitor 34 reads the volume page control table 43 to acquire values of the volume ID 431, the logical page no. 433, the physical page no. 434, and the accumulated IO count 435 and transmits the values to the global monitor 65. The global monitor 65 updates the monitor information collection table 75 based on these information.

In step S1002, the global monitor 65 refers to the global volume table 73 to classify the logical pages no. 752 in the monitor information collection table 75 for each volume type 762. The global monitor 65 sorts the logical pages no. classified for each volume type in descending order of the IOPH 763.

In addition, the global monitor 65 generates the global IO frequency distribution table 76 (FIG. 15) by arranging volume types from the volume type with the highest priority in descending order of the IOPH as the sort result.

In step S1003, the global monitor 65 calculates the allocated page capacity 772 for each volume type by multiplying the number of logical pages for each volume type 762 by the unit capacity (42 MB). Then the global monitor 65 updates the global used capacity table 77 (FIG. 16). In addition, the global monitor 65 updates the allocated page capacity 735 of the global volume table 73 (FIG. 7) with the calculated allocated page capacity 772.

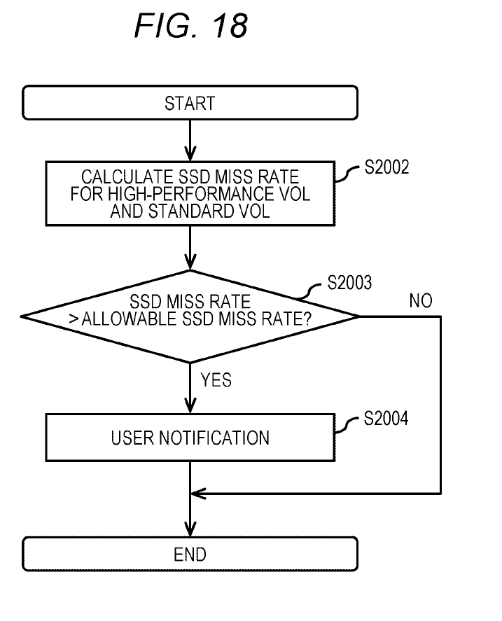

In step S1004, the global monitor 65 executes global tier capacity shortage determination processing shown in FIG. 18. As will be described later, in the global tier 1 capacity shortage determination processing, when the high-performance drive 20-S is insufficient, the shortage of the high-performance drive 20-S is notified through the display 56 of the management node 104. The storage administrator installs one or more additional high-performance storage nodes 103-1 or the high-performance drives 20-S on the basis of the notification content.

FIG. 18 is a flowchart showing an example of global tier 1 capacity shortage determination processing. This processing is processing performed in step S1004 of FIG. 17.

In step S2002, the global monitor 65 calculates logical values of the SSD miss ratio of access to the standard-performance volume (standard VOL) 200-2 and the SSD miss ratio of access to the high-performance volume (high-performance VOL) 200-1, from the global IO frequency distribution table 76 and the global volume table 73 (calculation by a total value for each volume type). In the case of the high cost-performance volume 200-3, the process may proceed to step S2005 to proceed to the next volume 200.

SSD miss ratio of standard VOL=1−(total of IOPH of SSD expectation page in all standard VOL)÷(total of IOPH of all pages of all standard VOL) (1)

SSD miss ratio of high-performance VOL=1−(total of IOPH of SSD expectation page in all high-performance VOL)÷(total of IOPH of all pages of all high-performance VOL) (2)

In the above equations, the SSD expectation page refers to pages that falls within the total chunk capacity 723 of the SSD (global tier 1) if the logical pages are allocated starting from the chunk 21-S of the high-performance drive 20-S (SSD) in the order of the page rank 761 of the global IO frequency distribution table 76.

That is, in the first embodiment, an SSD miss ratio is calculated from a ratio of a total value of the number (IOPH) of accesses to the SSD page and the number (IOPH) of accesses to the volume 200, for each type (priority) of the volume 200. The SSD miss ratio may be a ratio of the number of accesses to the HDD page in a case where access to the SSD page is theoretically possible.

Further, the SSD miss ratio may be a ratio of the capacity of non SSD pages in the volume and the capacity of the volume 200, for each type (priority) of the volume 200. That is, instead of the ratio of IOPH, the ratio of the capacity may be used. Instead of the SSD miss ratio, an SSD hit ratio may be used (SSD miss ratio+SSD hit ratio=1).

In the first embodiment, as will be described later, control is performed to allocate the chunk 21-S (SSD chunk) of the SSD of the high-performance global tier 1 to the standard VOL in addition to the high-performance VOL, so that the SSD miss ratio of the high-performance VOL is preferably maintained at 0 basically. Therefore, the allowable SSD miss ratio 786 of the high-performance VOL is set to “1%” and the SSD chunk of the global tier 1 is preferentially allocated.

On the other hand, since the SSD miss ratio of the standard VOL is set to “20%”, the SSD chunk (global tier 1) is allocated to 80% of the standard VOL and the HDD chunk is allocated to the remaining 20%.

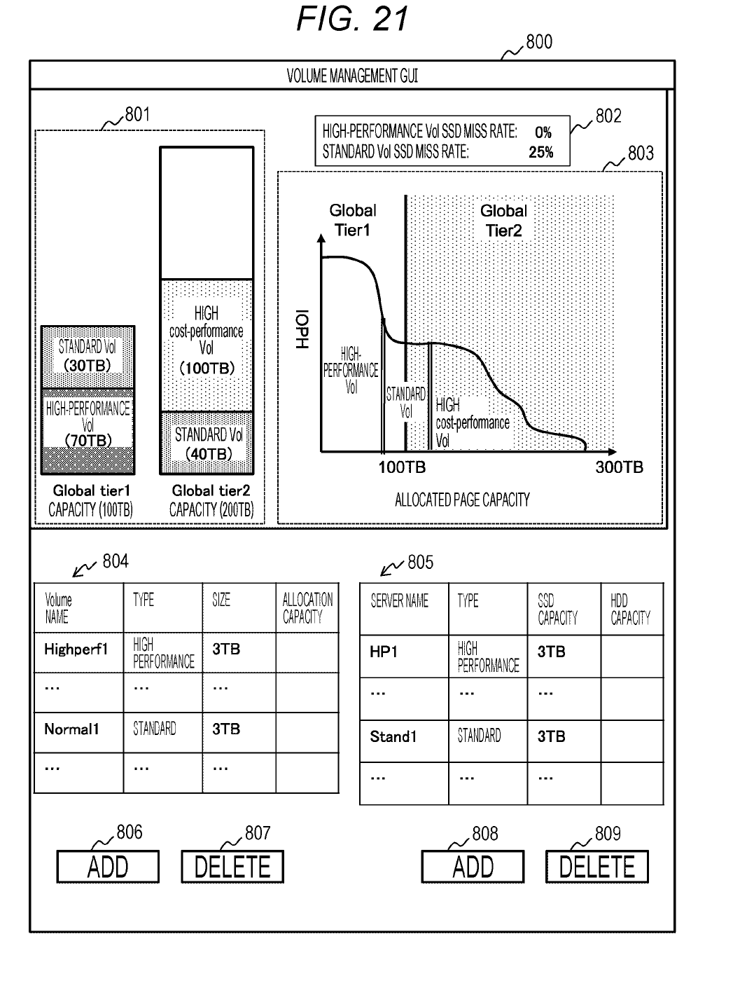

The SSD miss ratio of the standard VOL in the first embodiment functions as an index for showing the user where a boundary between the SSD chunk (global tier 1) and the HDD chunk (global tier 2) allocated to the standard VOL is positioned in the allocated pages as shown in FIG. 21 to be described later.

The SSD expectation page is not necessarily physically located in the SSD. The SSD expectation page may include pages which could be allocated to SSD by the global pool tier control or the local pool tiering 31 or the page which could be relocated to SSD through the rebalancing processing.

In step S2003, the global monitor 65 compares the calculated SSD miss ratio with the allowable SSD miss ratio 786 (FIG. 5) preset in the priority management table 78 and determines whether the SSD miss ratio of the volume 200 exceeds the allowable SSD miss ratio.

If the SSD miss ratio of the volume 200 exceeds the allowable SSD miss ratio, the global monitor 65 proceeds to step S2004 and if not, the global monitor 65 ends the processing.

In step S2004, the global monitor 65 outputs the shortage of the high-performance drive (SSD) 20-S to the display 56 and notifies the user (or the storage administrator) of the management node 104 of the possibility that the performance is degraded. The notification of the shortage of the high-performance drive (SSD) 20-S may be performed on a screen of FIG. 21 to be described later.

As a method in which the global monitor 65 outputs the notification, event notification using a management tool, SNMP notification, or other notification method can be used.

In the above example, the shortage of the SSD chunk of the high-performance VOL is detected by calculating the SSD miss ratio of the high-performance VOL or the SSD miss ratio of the standard VOL from the statistical information of the volume 200 and comparing the miss ratio with the allowable SSD miss ratio 786. However, the present invention is not limited thereto.

For example, by referring to the volume page control table 43 of the storage node 103, the management node 104 acquires the logical chunk ID 443 of the physical page control table 44 from the physical page no. 434 allocated to the volume 200. Further, the management node 104 can search for the local tier control table 41 with the logical chunk ID 443 to acquire the physical chunk ID 416 and can search for the global chunk control table 74 with the physical chunk ID 416 to acquire the global tier 744 allocated to the volume 200. Therefore, the shortage of the SSD page may be determined on the basis of the capacity of the global tier 1 allocated to the volume 200.

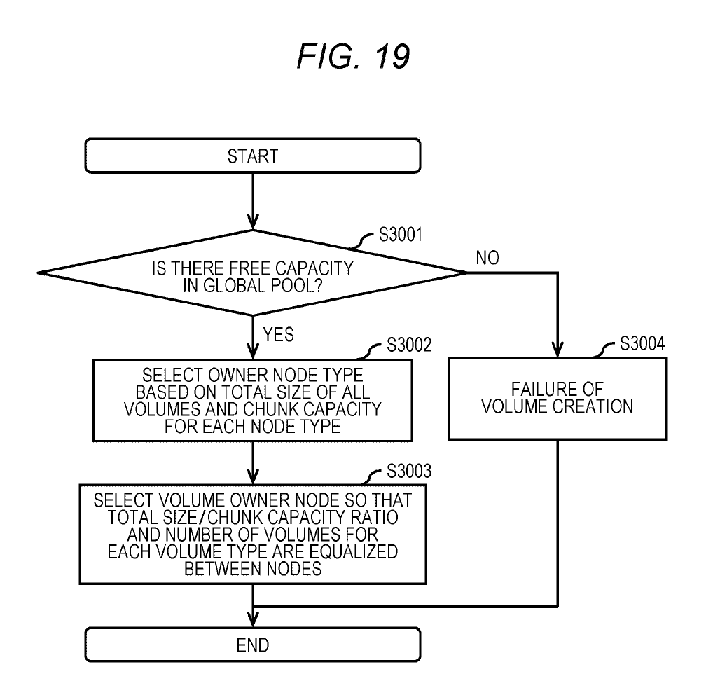

FIG. 19 is a flow chart showing an example of volume owner node selection processing performed by the management node 104. This processing is executed by the global volume management 63 of the management node 104 when the storage administrator of the management node 104 operates the input device 55 and inputs a predetermined command. In the command of the volume creation from the storage administrator, the necessary capacity and volume type are specified.

In step S3001, when the global volume management 63 first refers to the global used capacity table 77 and the global tiering table 72 to newly generate the volume 200, the global volume management 63 determines whether there is a free capacity in the global pool 24.

Specifically, the global volume management 63 compares a ratio of the total value of the allocated page capacity 772 of the global used capacity table 77 with respect to a total value (total chunk capacity value) of the total chunk capacity 723 of the global tiering table 72 and a predetermined threshold Th1 (for example, 90%). If the ratio (allocated page capacity/total chunk capacity value) is equal to or less than the threshold, the global volume management 63 determines that there is the free capacity and proceeds to step S3002. On the other hand, if the ratio exceeds the threshold, the global volume management 63 determines that there is no free capacity and proceeds to step S3004.

In step S3002, the global volume management 63 determines the node type 712 that can newly generate the volume 200. These processing searches a node type having a free capacity capable of generating the new volume 200 in the order of the priority owner node type 783 and the available owner node type 784 defined in the priority management table 78, for the volume type designated by the storage administrator. When a plurality of node types are designated as the available owner node type 784, searching is performed from the node type with high performance.

The global volume management 63 refers to the global node table 71 and the global volume table 73 to calculate a total value (total volume size) of the sizes 734 of all the volumes 200 and a total value (total chunk capacity) of the chunk capacity 717 for each node type 712.

When the ratio of the total volume size to the total chunk capacity for each node type (total volume size/total chunk capacity) is equal to or less than a threshold Th2 (for example, 2), the global volume management 63 determines that a new volume 200 can be created for the corresponding node type. On the other hand, when the ratio exceeds the threshold Th2, the global volume management 63 selects the node type set in the available owner node type 784 of the priority management table 78. The global volume management 63 may perform control for determining that the creation of the volume has failed when the ratio is equal to or less than the threshold Th2.

In step S3003, the global volume management 63 selects the storage node 103 newly generating the volume 200 so that the total value of the chunk capacity and the volume size and the number of volumes are maximally equalized between the storage nodes 103 of the node type selected in the above step S3002.

The global volume management 63 selects the storage node 103 in which a ratio of the total value of the volume size and the total value of the chunk capacity 717 and the number of the volumes 200 for each volume type 732 are equalized between the storage nodes 103 in the selected node type. For the selection of the storage node 103, a known method may be used. For example, an index for each storage node 103 may be calculated from the ratio and the number of volumes and each storage node 103 in which the index is within a predetermined range when the volume 200 is added may be selected. When it is predicted that the used capacity of each volume type 732 is almost the same or when it is difficult to predict the used capacity, the storage node 103 that creates the new volume 200 may be selected so that the number of volumes is equalized between the storage nodes 103.

On the other hand, in step S3004 where there is no free capacity, since there is no free capacity in the global pool 24, a notification that the creation of the volume 200 has failed is output to the display 56.

In the present embodiment, only the capacity for each node type is considered at the time of selecting the storage node 103 for generating the volume 200. However, in addition to the capacity, a load situation or availability of the storage node 103, a load situation or availability of the drive 20, and a load or a distance of the network may be considered.

By the above processing, the global volume management 63 of the management node 104 starts the volume owner node selection processing at the time of receiving an instruction of the volume creation from the user and selects the node type for the volume owner node. In addition, the global volume management 63 selects the node type so that the ratio of the chunk capacity and the total volume size for each node type falls below a constant value.

When the volume 200 is managed by thin provisioning, the volume size can be set larger than the total size of actual chunks. When the total volume size excessively increases, a new volume 200 can be created in the lower node type (available owner node type 784) which has the remaining SSD. As a result, it is expected that the SSD miss ratio of the new volume 200 is reduced. In addition, the global volume management 63 selects the storage node 103 for creating the new volume 200 so that the ratio of the chunk capacity and the total volume size between the storage nodes 103 is equalized among the nodes in the selected node type.

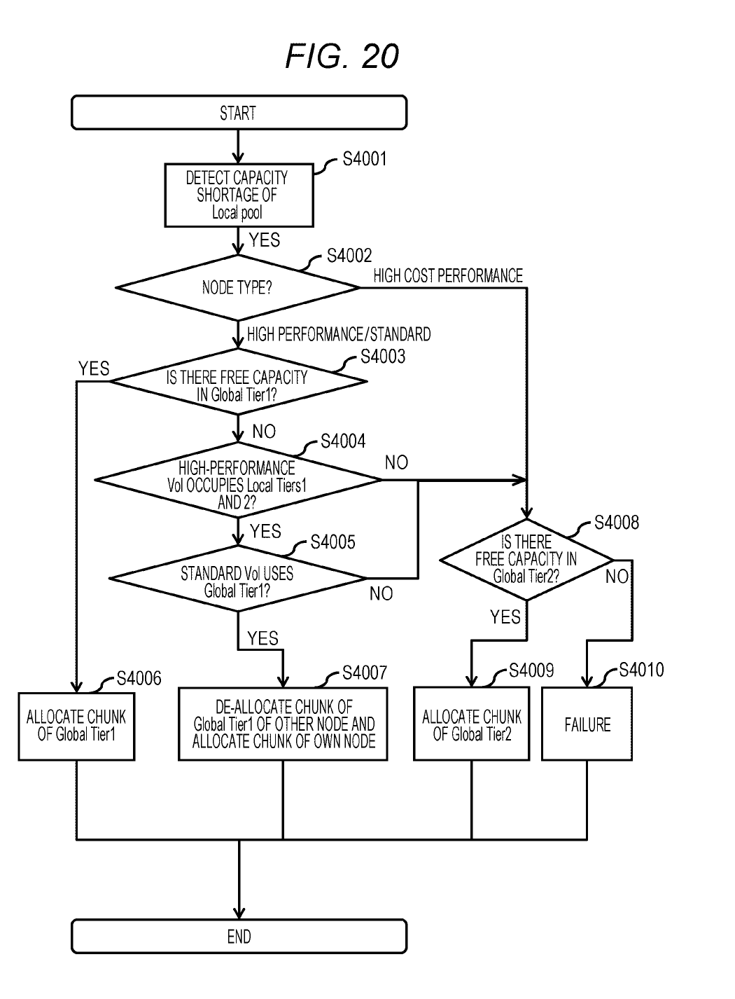

FIG. 20 is a flowchart showing an example of chunk allocation processing performed by the management node 104. The global chunk management 64 of the management node 104 receives a notification (notification of capacity shortage) from the local pool tiering 31 of the storage node 103 when the used ratio of the local tier 27 becomes equal to or more than the threshold Th2 (for example, 90%). After receiving the notification, the global chunk management 64 starts the chunk allocation processing for the storage node 103.

First, the global chunk management 64 receives a notification of the capacity shortage from the local pool tiering 31 of the storage node 103 (S4001). The global chunk management 64 acquires the type of the storage node 103 included in the notification of the capacity shortage.

In step S4002, the global chunk management 64 checks the acquired type. If the type is high performance or standard, the global chunk management 64 proceeds to step S4003 and if the acquired type is high cost performance, the global chunk management 64 proceeds to step S4008.

In step S4003, the global chunk management 64 refers to the global tiering table 72 to determine whether there is free capacity in the global tier 1 (25-1). If there is free capacity in the global tier 1 (25-1), the global chunk management 64 proceeds to step S4006 and if not, the global chunk management 64 proceeds to step S4004.

In step S4006, the global chunk management 64 allocates the chunk 21-S of the SSD from the global tier 1 (25-1) to the target storage node 103. Then, the global chunk management 64 notifies the target storage node 103 of the additional allocation of the chunk 21-S and ends the processing.

In step S4004, the global chunk management 64 inquires of the local monitor 34 of the target storage node 103 whether the local tier 1 (27-1) and the local tier 2 (27-2) are occupied by the high-performance volume 200-1.

The local monitor 34 refers to the local volume management table 42 and the local tier control table 41, determines the state whether the high-performance volume 200-1 occupies the local tiers 1 and 2, and responds to the global chunk management 64 of the management node 104.

According to the reply from the target storage node 103, if the high-performance volume 200-1 occupies the local tier 1 (27-1) and the local tier 2 (27-2), the global chunk management proceeds to step S4005 and if not, the global chunk management 64 proceeds to step S4008.

In step S4005, the global chunk management 64 refers to the global IO frequency distribution table 76, the global used capacity table 77, and the global tiering table 72 and determines whether there is a volume using the global tier 1 (SSD) among the standard volumes 200-2. If there is the standard volume 200-2 using the global tier 1, the global chunk management 64 proceeds to step S4007. If the SSD is used, the global chunk management 64 proceeds to step S4008.

In step S4007, the global chunk management 64 specifies the storage node 103 to which the standard volume 200-2 using the global tier 1 belongs, from the global volume table 73 and the global chunk control table 74. This can be calculated from the sum of the allocated page capacity 735 for each volume type in each owner node and the allocated chunk capacity 745 of the global tier 1.

In addition, the global chunk management 64 de-allocates the chunk 21-S of the SSD from the standard volume 200-2 of the specified storage node 103 and allocates the chunk to the target storage node 103.

For the de-allocation of the chunk 21-S, when the chunk 21-S of the SSD is replaced with the chunk 21-H of the HDD in the standard volumes 200-2 using the local tiers 1 and 2, the global chunk management 64 can select the volume 200-2 with the least decrease of the SSD miss ratio calculated by the above formula (1).

The global chunk management 64 notifies the target storage node 103 of the addition of the de-allocated chunk 21-S and ends the processing.

When the node type is a high cost-performance node or when the standard volume 200-2 does not use the global tier 1, the global chunk management 64 determines that only the high-performance volume 200-1 uses the global tier 1. In this case, since the chunk 21-S of the global tier 1 cannot be de-allocated from another node, the global chunk management 64 proceeds to step S4008.

In step S4008, the global chunk management 64 refers to the global tiering table 72 to determine whether there is a free chunk 21-H in the global tier 2 (25-2). If there is the free chunk in the global tier 2 (25-2), the global chunk management 64 proceeds to step S4009. If there is no free chunk, the global chunk management 64 proceeds to step S4010.

In step S4009, the global chunk management 64 allocates the free chunk 21-H from the global tier 2 (25-2) to the target storage node 103 and notifies the storage node 103 of the allocation of the chunk.

On the other hand, in step S4010, because there is no free chunk in the global tier 2 (25-2) and the chunk 21 cannot be allocated, the global chunk management 64 issues a notification of an allocation failure to the display 56 and notifies the storage administrator of the allocation failure.

By the above processing, the global chunk management 64 allocates the chunk 21-S of the global tier 1 (25-1) to the high-performance volume 200-1 or the standard volume 200-2. In addition, when there is no free chunk 21-S in the global tier 1 (25-1), the global chunk management 64 de-allocates the chunk 21-S of the high-performance volume 200-1 used by the standard volume 200-2 and performs re-allocation to the high-performance volume 200-1. Furthermore, when the standard volume 200-2 does not use the global tier 1 (25-1), the global chunk management 64 allocates the free chunk 21-H of the global tier 2 (25-2).

### Management Interface

FIG. 21 is a diagram showing an example of a volume management GUI 800. For example, the volume management GUI 800 is generated by the global volume management 63 according to a request from the user and is displayed on the display 56.

The volume management GUI 800 includes a region 801 for displaying the volume 200 to which the chunks 21 of the global tiers 1 and 2 have been allocated as a bar graph for each volume type, an SSD miss ratio display region 802 for displaying each of an SSD miss ratio of the high-performance VOL and an SSD miss ratio of the standard VOL, a display region 803 for displaying the volume 200 to which the chunks 21 of the global tiers 1 and 2 have been allocated by a graph of the IOPH and the allocated page capacity for each type of volume, a volume list 804, a node list 805, an addition button 806 of the volume 200, a deletion button 807 of the volume 200, an addition button 808 of the storage node 103, and a deletion button 809 of the storage node 103.

The graph of the display region 803 is obtained by plotting the global IO frequency distribution table 76 of FIG. 15 as a line graph. In the graph, a vertical axis shows the IOPH and a horizontal axis shows the allocated page capacity for each type. Along the horizontal axis, the display region is divided into the high-performance VOL, the standard VOL, and the high cost-performance VOL in this order from the left side. In addition, along the horizontal axis, the display region is divided into a region of the global tier 1 and a region of the global tier 2 on the graph.

If a boundary between the global tier 1 and the global tier 2 is in the region of the high cost-performance volume, an allocation amount of the SSD to the standard VOL and the high-performance VOL is sufficient.

On the other hand, if the boundary between the global tier 1 and the global tier 2 is closer to the right side of the high-performance VOL (200-1) than the right of the standard VOL (volume 200-2), it can be determined that an allocation amount of the SSD to the volume 200 is insufficient.

If the boundary between the global tier 1 and the global tier 2 enters the region of the high-performance VOL and the SSD miss ratio exceeds the allowable SSD miss ratio as shown in FIG. 18, the shortage of the SSD of the global tier 1 is detected and a notification of insufficient allocation of the SSD is output.

In the volume list 804, a name, a type, a size, and an allocated page capacity of the volume 200 managed by the management node 104 are displayed.

In the node list 805, a server name, a type, an SSD (local tier 1) capacity, and an HDD (local tier 3) capacity of the storage node 103 managed by the management node 104 are displayed.

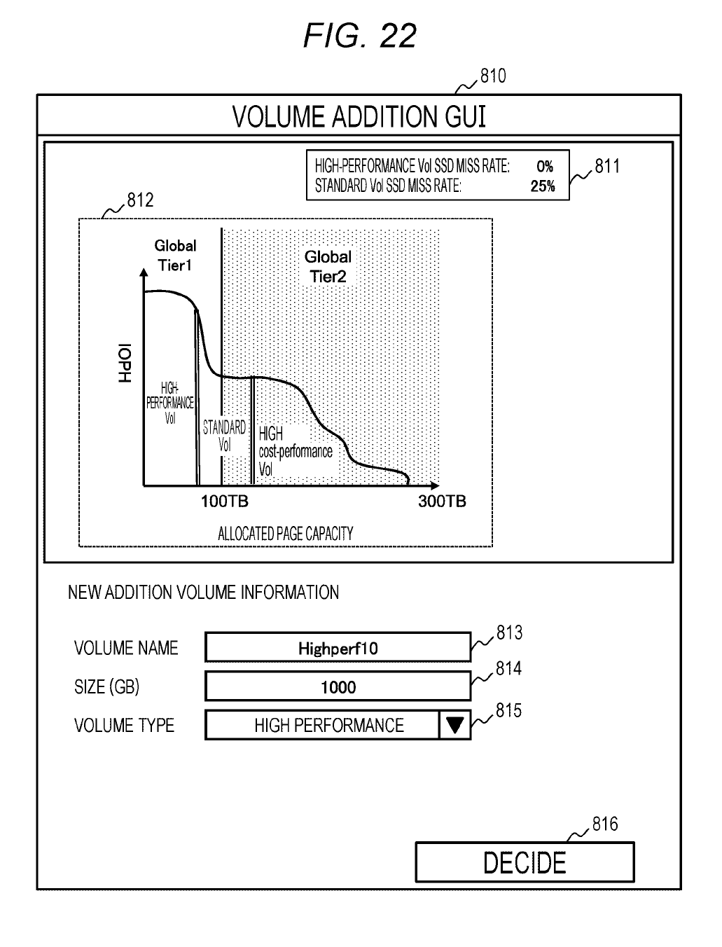

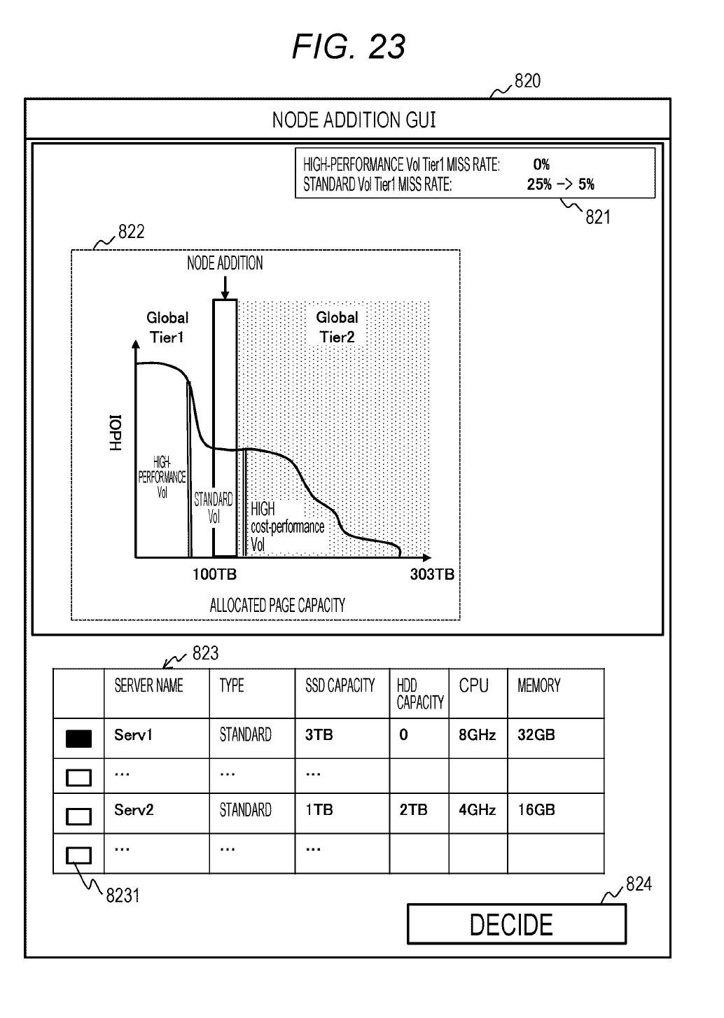

In the volume management GUI 800, addition or deletion of the volume 200 or the storage node 103 can be performed. By clicking the addition button 806 of the volume, addition processing of the volume 200 can be started from a volume addition GUI 810 of FIG. 22. By clicking the addition button 808 of the node, addition processing of the storage node 103 can be started from a node addition GUI 820 of FIG. 23.

In the volume management GUI 800, by selecting an unnecessary volume in the volume list 804 and clicking the deletion button 807, the corresponding volume 200 can be deleted.

Similarly, by selecting an unnecessary server name in the node list 805 and clicking the deletion button 809, the corresponding storage node 103 can be deleted.

FIG. 22 is a diagram showing an example of the volume addition GUI 810. The volume addition GUI 810 is displayed on the display 56 by the global volume management 63 when the addition button 806 of the volume is clicked.

The volume addition GUI 810 displays an SSD miss ratio display region 811, a display region 812 for displaying the volume 200 to which the chunks 21 of the global tiers 1 and 2 have been allocated by a graph of the IOPH and the capacity for each type of volume, a name 813 of the volume 200 to be added, a size 814 of the volume 200 to be added, a type 815 of the volume 200 to be added, and a decision button 816 to start the addition processing of the volume 200.

The SSD miss ratio display region 811 and the display region 812 are the same as those of the volume management GUI 800 of FIG. 21. The user of the management node 104 can add the new volume 200 by filling out the name 813, the size 814, and the type 815 of the volume 200 to be added and clicking the decision button 816.

FIG. 23 is a diagram showing an example of the node addition GUI 820. The node addition GUI 820 is displayed on the display 56 by the global node management 61 when the addition button 808 of the node is clicked.

The volume addition GUI 820 displays an SSD miss ratio display region 821, a display region 822 for displaying the volume 200 to which the chunks 21 of the global tiers 1 and 2 have been allocated by a graph of the IOPH and the capacity for each type of volume, a list 823 of nodes to be newly added, and a decision button 824 to start the addition processing of the storage node 103.

In the list 823, a selection button 8231, a server name, a type, an SSD capacity, an HDD capacity, a CPU, and a memory are displayed. In the example shown in the drawing, “Serv1” of the standard node is selected in the list 823.

In the SSD miss ratio display region 821, an SSD miss ratio before and after the addition of “Serv1” of the standard node is displayed. In the example shown in the drawing, the SSD miss ratio of the standard VOL is improved from 25% to 5% by adding the standard node (103-2).

In the display region 822, in addition to the contents of the volume management GUI 800 of FIG. 21, a region of the volume 200 when “Serv1” of the standard node is added is displayed as a “node addition” in the drawing. As a result, the user of the management node 104 can grasp the performance of the selected storage node 103.

In addition, the user can add a new storage node 103 by clicking the decision button 824.

As described above, in the first embodiment, in the storage node 103 that includes the high-performance VOL (200-1) to which the page of the SSD (20-S) has been allocated and the standard VOL (200-2) to which the page of the SSD can be allocated and controls the priority of the performance, the used capacity (allocated page capacity) for each volume 200 and the IOPH (statistical information on the performance of the volume 200) are acquired and the SSD miss ratio is calculated, so that the shortage of the chunks of the global tier 1 allocated to the high-performance VOL or the standard VOL can be notified.

As a result, it is possible to notify the storage administrator of the management node 104 that the high-performance storage device (for example, the SSD) is insufficient. The storage administrator of the storage system can install the additional drives before the performance is degraded due to the shortage of the high-performance volume 200-1. As a result, the storage administrator does not need to always monitor the performance information and the management cost can be reduced.

In the first embodiment, the three types of high-performance VOL, standard VOL, and high cost-performance VOL are used as the volume type. However, the present invention is not limited thereto. In addition, a node type for each user application or a node type with a finer priority may be used. The same is applied to the node type of the storage node 103.

In addition, although the type of the drive 20 is set as two types of SSD and HDD, the present invention is not limited thereto. For example, a type is defined for a storage class memory that is a high-speed storage device, and even the same type of storage devices may be classified into some drive types depending on their processing characteristics such as read specialization and write specialization.

In addition, although the example using the SSD miss ratio as the method of determining the shortage of the high-performance volume 200-1 such as the SSD is shown, the present invention is not limited thereto. For example, when the IOPH of the page with the lowest access among the SSD expected pages exceeds the IOPH supported by the HDD drive as the specification, it may be determined that the SSD is insufficient.

In the first embodiment, the example in which the storage administrator selects the type of the volume at the time of creating the new volume 200 has been shown. However, the volume type may be designated by the global volume management 63 automatically.

In the first embodiment, the example in which the shortage of the SSD is notified to the user of the management node 104 when the SSD is insufficient has been shown. However, the notification may be performed as availability of creation of the volume 200 at the time of creating the volume 200 in FIG. 19.

### Second Embodiment

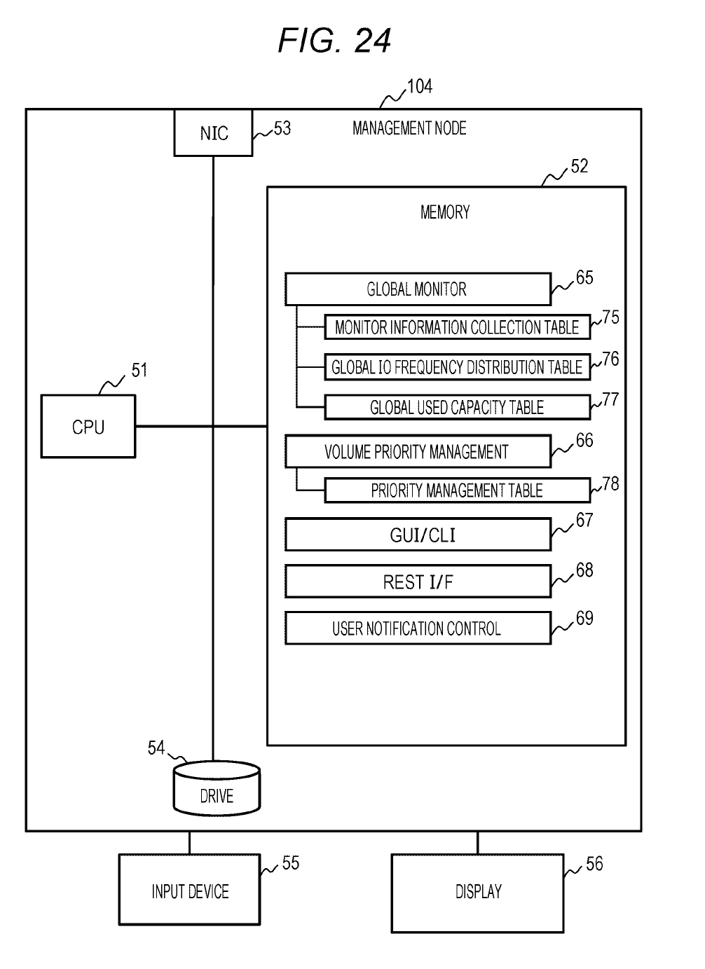

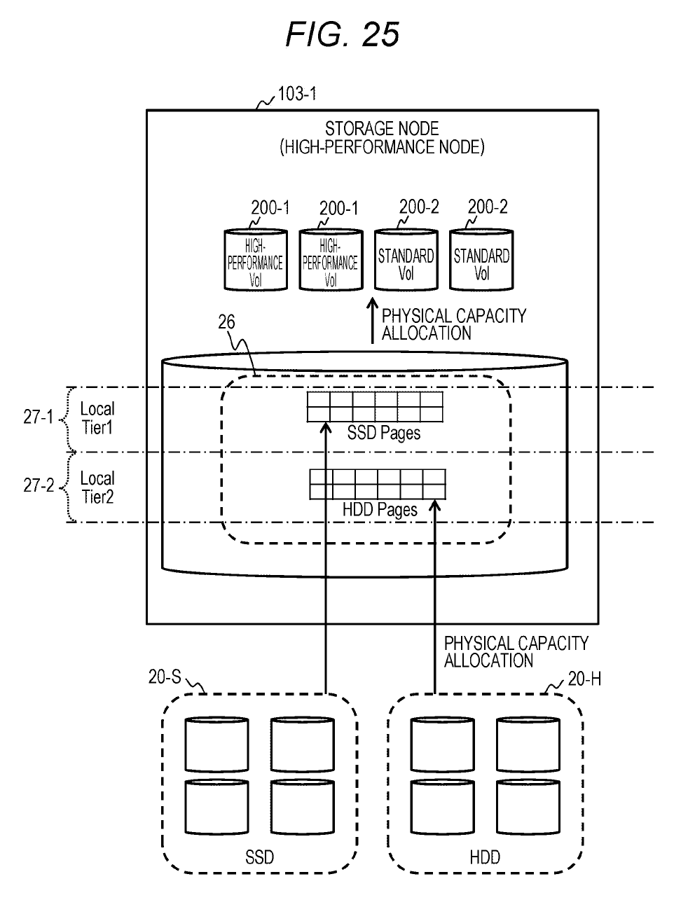

FIGS. 24 and 25 show a second embodiment of the present invention. In the second embodiment, an example of a storage system in which a global pool 24 of the first embodiment is removed and a management node 104 manages a local pool 26 of a storage node 103 is shown.

FIG. 24 is a block diagram showing an example of the management node 104 according to the second embodiment. The management node 104 according to the second embodiment is obtained by removing a global node management 61, a global pool tier control 62, a global volume management 63, a global chunk management 64, and tables used by these functional units from the configuration of FIG. 3 of the first embodiment and the other configuration is the same as that of the first embodiment.

The management node 104 according to the second embodiment monitors an IO frequency distribution and a used capacity of the storage node 103, using tables of FIGS. 14 to 16 in the first embodiment. However, in the second embodiment, since the global pool is not used, a global IO frequency distribution table 76 of FIG. 15 and a global used capacity table 77 of FIG. 16 may be generated in a unit of the storage node 103. In addition, the global IO frequency distribution table 76 and the global used capacity table 77 may be generated in each storage node 103.

The storage node 103 according to the second embodiment is the same as that of the first embodiment shown in FIG. 2. However, the storage node 103 allocates a storage region from drive s 20 of the own node to a volume 200. In the second embodiment, the storage node 103 is configured to allocate pages of the drives 20 to the volume 200 without using chunks shown in the first embodiment. In addition, each storage node 103 controls the local pool 26 using tables of FIGS. 10 to 13 in the first embodiment.

FIG. 25 is a block diagram showing an example of the local pool 26 of the storage node 103. In a storage node 103-1 (high-performance node), priority control of the volume 200 is performed by a high-performance drive 20-S and a high cost-performance drive 20-H.

The storage node 103 has a plurality of high-performance drives 20-S and high cost-performance drives 20-H and performs the tier control of the local pool 26. The local pool 26 has two tiers that include a local tier 1 (27-1) to which pages (SSD pages) of the high-performance drive 20-S have been allocated and a local tier 2 (27-2) to which pages (HDD pages) of the high cost-performance drive 20-H have been allocated.

The management node 104 preferentially allocates the SSD pages of the local tier 1 (27-1) to the high-performance volume 200-1 and allocates the HDD page of the local tier 2 to a standard volume 200-2 (standard VOL) with lower priority when the SSD page of the local tier 1 does not remain.

A local monitor 34 of the storage node 103 is the same as that of the first embodiment, and calculates an IO frequency (or IOPH) as statistical information showing performance of the volume 200 and notifies the management node 104 of the IO frequency.

The management node 104 acquires IO statistical information and a used capacity for each type of the volume 200 from the storage node 103 and manages the used capacity and the IO frequency distribution for each volume type for each local pool 26. In addition, the management node 104 determines the shortage of an SSD on the basis of the above information. If the shortage of the SSD occurs, the management node 104 notifies a user of the shortage of the SSD. After performing the notification to the user of the management node 104, selection processing (FIG. 19) of the storage node 103 creating the volume may be executed.

The management node 104 executes processing of the first embodiment shown in FIGS. 17 and 18. When the SSD is insufficient, the management node 104 outputs the notification to the display 56. In the second embodiment, in the selection processing of the storage node 103 newly creating the volume 200, only step S3003 of FIG. 19 is executed to prevent a load from being concentrated between a plurality of storage nodes 103.

As described above, in the second embodiment, even when tier control is performed in the local pool 26 for each storage node 103, the used capacity and the IOPH (IO statistical information) for each volume 200 are acquired and the SSD miss ratio is calculated, so that it is possible to output a notification showing detection of the shortage of the SSD pages allocated to the high-performance volume 200-1. As a result, it is possible to add the SSD before the performance of the high-performance volume 200-1 is degraded.

### Third Embodiment

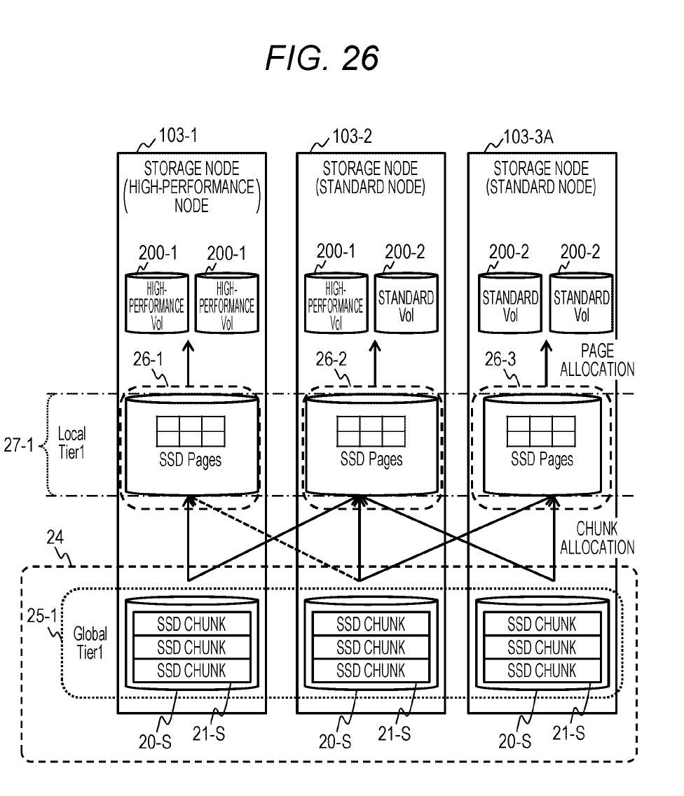

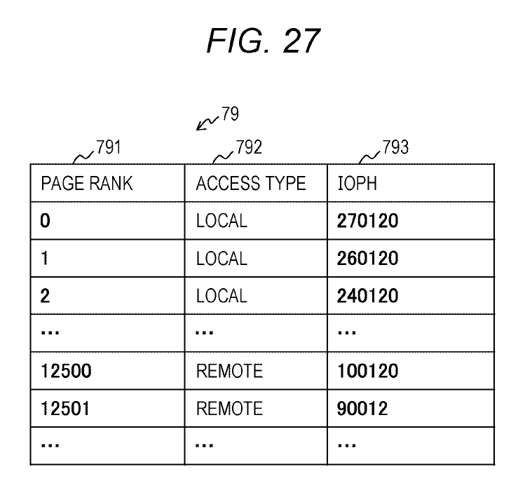

FIGS. 26 and 27 show a third embodiment of the present invention. In the third embodiment, an example of, in a storage system in which tiers (local tiers 27-2 and 27-3) of a local pool 26 of the first embodiment are removed to constitute a single tier (local tier 27-1) and chunks 21 are provided from a global pool 24 to a plurality of storage nodes 103 having the local pool 26 not performing tier control, performing determination of a capacity shortage of a volume 200 of the local pool 26 and a notification of the capacity shortage is shown.

FIG. 26 is a block diagram showing a relation between the global pool 24 and the local pool 26. Each storage node 103 constitutes the local pool 26 with a high-performance drive 20-S in an own node and a high-performance drive 20-S of another storage node 103 (another node).

In the third embodiment, the local pool 26 is constituted with only the high-performance drive 20-S (SSD) in the own storage node 103, so that access performance of the volume 200 can be increased. In particular, only the chunk 21 (hereinafter, referred to as a local chunk) of a local node (own node) is allocated to a high-performance volume 200-1.

On the other hand, when thin provisioning is applied to the management of the volume 200, it is possible to create the volume 200 having a physical capacity or more. In the thin provisioning, since the capacity of the volume 200 used by a user is equal to or less than a size of the volume 200, capacity efficiency can be improved by performing over provisioning.

In the operation of the thin provisioning, when the used capacity of the volume 200 exceeds the capacity of the local drive 20-S, a chunk 21-S (hereinafter, referred to as a “remote chunk”) provided from another storage node 103 is allocated and access performance decreases.

The remote chunk has lower performance than the local chunk because of a delay of a network and the like and a restriction of a band of the network and the like. For this reason, in the third embodiment, the local chunk is handled as a high-performance storage device and the remote chunk is handled as a low-performance storage device.

In the third embodiment, a management node 104 acquires an actual used capacity of the volume 200, a capacity of a local SSD (local chunk) of the local pool 26, a physical capacity of a remote SSD (remote chunk), and IO statistical information (IOPH) and determines whether SSD pages of the local pool 26 are sufficient on the basis of an IO amount of the remote chunk or an SSD allocation amount of the remote chunk.

When the capacity of the SSD page of the local pool 26 in the storage node 103 (own node) is insufficient to satisfy the performance requirement, this is notified to a user of the management node 104. The user adds an SSD device to the storage node 103 shown in the notification, thereby eliminating a capacity shortage of the SSD page. Alternatively, when the remote chunk of the own node is allocated to a standard volume 200-2 with low priority in another storage node 103 (another node), the management node 104 de-allocates the remote chunk of the own node from another node, thereby eliminating the capacity shortage of the SSD page. By the above processing, the user does not need to always monitor the capacity shortage of each storage node 103 and it is possible to add a device at necessary timing.

The management node 104 allocates the de-allocated remote chunk as the local chunk to the local pool 26 of the own node, thereby eliminating the capacity shortage of the SSD page. The management node 104 allocates an insufficient chunk to another node from which the remote chunk has been de-allocated.

In the third embodiment, an example of using the SSD (20-S) as the type of the drive 20 is shown. However, the present invention can be applied even when a high-speed device such as an NVRAM or a low-speed device such as an HDD is used.

A configuration of the storage system of the third embodiment is the same as that of the first embodiment shown in FIGS. 1 to 3, except that tier control of the local pool 26 and the global pool 24 is not performed and a thin provisioning function of the global pool 24 is used. In the third embodiment, only the chunk 21-S of the SSD of the global pool 24 is used and the SSD page of the local tier 27-1 is used in the local pool 26.

Only the local chunk is allocated to the high-performance volume 200-1 (high-performance VOL) and the local chunk or the remote chunk is allocated to the standard volume 200-2 (standard VOL). Since the HDD is not used in the third embodiment, instead of a storage node 103-3 of FIG. 4, a storage node 103-3A of a standard node constituted by the standard volume 200-2 is used

The management node 104 controls the global pool 24 using tables of FIGS. 5 to 9 in the first embodiment. In addition, it is assumed that an allowable SSD miss ratio 786 of FIG. 5 is read as an allowable local miss ratio.

Local miss ratio=IOPH to remote chunk/IOPH to local chunk (3)

The management node 104 calculates the local miss ratio using a monitor information collection table of FIG. 14 and a local pool IO frequency distribution table 79 of FIG. 27.

FIG. 27 is a diagram showing an example of a configuration of the local pool IO frequency distribution table 79. The local pool IO frequency distribution table 79 is a table in which the global monitor 65 of the management node 104 manages the distribution of the IO frequency of the local pool 26 in units of pages.

The local pool IO frequency distribution table 79 includes a page rank 791, an access type 792, and an IOPH 793 in one entry. In the page rank 791, a rank of the IOPH of the logical page is stored. In the present embodiment, an example in which the rank is set in descending order with the logical page with the maximum IOPH as the first logical page is shown.

In the access type 792, information on whether the logical page corresponding to the rank is configured by a local chunk or a remote chunk is stored. In the IOPH, the IOPH 763 of the logical page corresponding to the rank is stored.

A field of the logical page no. may be added to the local pool IO frequency distribution table 79 so that the volume 200 can be easily specified.

Each storage node 103 controls the local pool 26 using tables of FIGS. 10 to 13 in the first embodiment. As described above, only one tier of the local pool 26 is controlled.

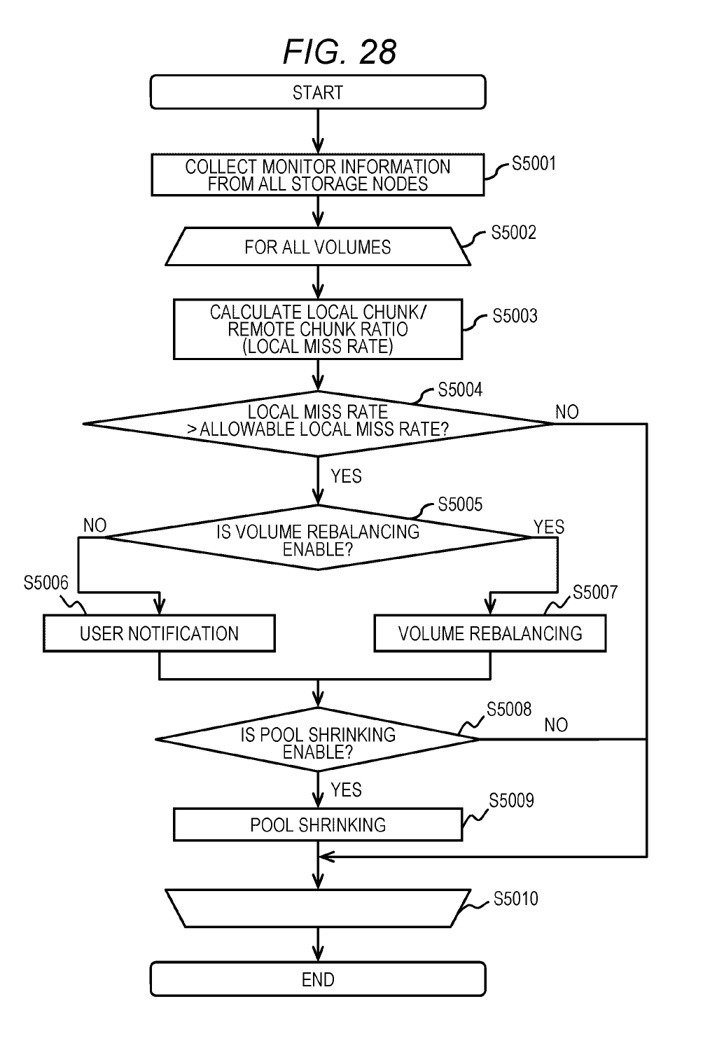

FIG. 28 is a flowchart showing an example of global tier 1 capacity shortage determination processing performed by the management node 104. The flowchart is executed by the global monitor 65 of the management node 104 at a predetermined cycle (for example, one hour). When the capacity shortage of the local chunk of the storage node 103 is detected by the above processing, the management node 104 deals with the capacity shortage of the SSD of the local pool 26 by the user notification or the chunk rebalancing.

In step S5001, the global monitor 65 of the management node 104 collects monitor information from the local monitor 34 of each storage node 103 and generates the monitor information collection table 75 of FIG. 14 or the local pool IO frequency distribution table 79, similar to the first embodiment.

In step S5002, the global monitor 65 repeats the processing up to step S5010 for all the volumes 200 registered in the monitor information collection table 75.

In step S5003, the global monitor 65 calculates the ratio of the IO accesses of the remote chunk and the local chunk for the volume 200 of each storage node 103 as a local miss ratio from the above formula (3).

In step S5004, the global monitor 65 determines whether the local miss ratio has exceeded the allowable local miss ratio (allowable SSD miss ratio in the drawing) of the priority management table 78. If the local miss ratio exceeds the allowable local miss ratio, the global monitor 65 determines that the capacity shortage of the local chunk occurs and proceeds to step S5005, and if not, the global monitor 65 proceeds to step S5010, selects the next volume 200, returns to step S5002, and repeats the above processing.

In step S5005, the global monitor 65 refers to a global node table 71 to acquire a free chunk capacity of another storage node 103, and determines whether the volume 200 of the storage node 103 of which the capacity has become insufficient can be rebalanced by the remote chunk of another storage node 103.

In the determination of rebalancing, if a remote chunk of an own node is allocated to the volume 200 of another node and there is a free chunk capacity that can be allocated to the volume 200 of another node, the global monitor 65 determines that the rebalancing is enabled and if not, the global monitor 65 determines that the rebalancing is not enabled.

If the volume can be rebalanced, the global monitor 65 proceeds to step S5007 and if not, the global monitor 65 proceeds to step S5006.

In step S5007, as described above, when the storage node 103 (own node) whose capacity of the local chunk has become insufficient provides the remote chunk to another node, the global monitor 65 de-allocates the remote chunk from the volume 200 of another node and allocates the remote chunk as the local chunk to the volume 200 of the own node. The global monitor 65 allocates another chunk to the volume 200 of another node from which the remote chunk has been de-allocated.

Similar to the first embodiment, the global monitor 65 can select a standard volume 200-2 from which the remote chunk can be de-allocated, based on the volume type 762 and the page rank 761 of the global IO frequency distribution table 76.

In step S5006, similar to the first embodiment, information showing that performance may be degraded due to the insufficient local chunk is output to a display 56 to notify a user that a high-performance device (local chunk) is insufficient. The output contents include a node ID 711 of the storage node 103 in which the device is insufficient, so that the user can add a device to the node.

Next, in step S5008, the global monitor 65 determines whether the sufficient physical capacity is allocated even if a chunk allocation amount is decreased, with respect to the used capacity of the target volume 200 in the storage node 103. If the used capacity/physical capacity is equal to or more than predetermined free ratio, for example, 70% or more, it is determined that shrinking of the local pool 26 is allowable even reserving the sufficient physical capacity.

If the pool can be shrunk, the global monitor 65 proceeds to step S5009 and execute the shrinking of the local pool 26. If not, the global monitor 65 proceeds to step S5010 and executes the above processing for the next volume 200.

In step S5009, the global monitor 65 removes the remote chunk from the target volume 200, executes the shrinking of the local pool 26, and reduces allocation of the remote chunk to the volume 200.

By the above processing, even in the case of operating the volumes 200-1 and 200-2 having a different performance in the local chunk and the remote chunk by using the single type of drive 20-S (SSD), in the storage node 103, which includes the high-performance VOL (200-1) to which the page of the local chunk is allocated and the standard VOL (200-2) to which the remote chunk can be allocated and which controls the priority of the performance, the used capacity and the IOPH (IO statistical information) for each volume 200 are acquired and the local miss ratio is calculated. As a result, the shortage of the local chunk allocated to the storage node 103 of the high-performance VOL can be notified.

In the third embodiment, the monitor information is used for calculating the local miss ratio. However, the present invention is not limited thereto. For example, in a storage system having a pool performing IO load distribution control between the chunks, the local miss ratio may be calculated from a capacity ratio of a local device capacity and a remote device capacity included in the pool.

### Summary

As described above, in the first to third embodiments, in the storage system that provides the high-performance volume to which the storage region of the SSD is preferentially allocated and the low-performance volume to which the storage region of the SSD or the HDD is allocated, in the storage node 103 having the high-performance storage device (SSD) and the low-performance storage device (HDD), the management node 104 detects the shortage of the SSD allocated to the high-performance volume and issues the notification. As a result, the SSD can be allocated to the high-performance volume before the performance of the high-performance volume is degraded due to the shortage of the SSD.

The management node 104 sets the higher priority for allocating the SSD to the high-performance volume than to the low-performance volume. Further, the management node 104 calculates the SSD miss ratio (index) from the statistical information on the performance such as the accumulated IO count per unit time for each volume 200, the transfer speed, and the transfer amount and the priority and compares the SSD miss ratio with the predetermined allowable value (allowable SSD miss ratio 786), thereby detecting the allocation shortage of the SSD quickly.

As described above, in the storage system in which the management node 104 calculates the index (SSD miss ratio) showing the shortage of the high-performance device on the basis of the statistical information on the performance and the priority and the high-performance volume having the high priority for allocating the high-performance storage device and the low-performance volume having the low priority are operated, the shortage of the high-performance storage device can be notified before the performance of the high-performance volume is degraded.

In the first to third embodiments, the example in which the management node 104 is constituted by independent computers has been shown. However, the management node 104 may be executed by any one of the storage nodes 103-1 to 103-n.

The first to third embodiments can be applied to a large-scale storage system in addition to the SDS.

The present invention is not limited to the embodiments described above and various modifications are included. For example, the embodiments are described in detail to facilitate the description of the present invention and are not limited to including all of the described configurations. In addition, a part of the configurations of the certain embodiment can be replaced by the configurations of other embodiments or the configurations of other embodiments can be added to the configurations of the certain embodiment. In addition, for a part of the configurations of the individual embodiments, addition of other configurations, configuration removal, and configuration replacement can be applied independently or combinedly.

In addition, a part or all of the individual configurations, functions, processing units, and processing mechanisms may be designed by integrated circuits and may be realized by hardware. In addition, the individual configurations and functions may be realized by software by interpreting programs for realizing the functions by a processor and executing the programs by the processor. Information such as the programs, the tables, and the files for realizing the individual functions may be stored in a recording device such as a memory, a hard disk, and a solid state drive (SSD) or a recording medium such as an IC card, an SD card, and a DVD.

In addition, only control lines or information lines necessary for explanation are shown and the control lines or information lines do not mean all control lines or information lines necessary for a product. In actuality, almost all configurations may be mutually connected.

What is claimed is:

1. A storage system including a storage node having a processor and a storage device storing data, wherein
a first storage device and a second storage device having different performances are included in the storage system,
the processor manages a volume having a storage region to which the storage device is allocated and performs an input/output of data for the storage device via the volume,
the processor calculates an input/output frequency relating to the input or/and the output of the data for each storage region and manages volume configuration relating to an allocation amount of each of the first and second storage devices to the volume,
a management unit acquires the input/output frequency from the processor and generates distribution information of the input/output frequency in the volume for each volume, and
the management unit determines performance of the volume on the basis of the distribution information of the input/output frequency in the volume and the volume configuration of the storage device of each performance to the volume.

2. The storage system according to claim 1, wherein
the storage system has a plurality of storage nodes connected to a network,
each of the plurality of storage nodes has the first storage device or/and the second storage device, and
the management unit acquires the volume configuration and the distribution information of the input/output frequency from processors of the plurality of storage nodes and determines the performance of the volume.

3. The storage system according to claim 2, wherein
the storage node can allocate a storage device of another storage node to the volume of the own node.

4. The storage system according to claim 2, wherein
the management unit is disposed in a management node connected to the network.

5. The storage system according to claim 1, wherein,
when the performance of the volume is lower than a predetermined threshold, it is determined that the first storage device having high performance is insufficient.

6. The storage system according to claim 5, wherein
the storage node has a plurality of volumes having different performances and
the threshold is determined for each of the volumes having the different performances.

7. The storage system according to claim 5, wherein,
in a first capacity in which the first storage device having the high performance in the volume configuration is allocated to the volume, when a ratio of the storage region of the first capacity of the upper side in the distribution information of the input/output frequency is smaller than a predetermined value, it is determined that the first storage device is insufficient.

8. The storage system according to claim 6, wherein,
when the first storage device is insufficient, the allocation of the first storage device to another volume is released and the released first storage device is allocated to the volume determined to be insufficient.

9. A method of controlling a storage system including a storage node having a processor and a storage device storing data,
a first storage device and a second storage device having different performances being included in the storage system,
the method comprising: causing the processor to manage a volume having a storage region to which the storage device is allocated and perform an input/output of data for the storage device via the volume;
causing the processor to calculate an input/output frequency relating to the input or/and the output of the data for each storage region and manage volume configuration relating to an allocation amount of each of the first and second storage devices to the volume;
causing a management unit to acquire the input/output frequency from the processor and generate distribution information of the input/output frequency for each volume in the volume; and
causing the management unit to determine performance of the volume on the basis of the distribution information of the input/output frequency in the volume and the volume configuration of the storage device of each performance to the volume.
